(19) United States
(12) Patent Application Publication
(10) Pub. No.: US 2026/0333313 A1
(43) Pub. Date: Oct. 22, 2026

(54) ENHANCED SCHEDULING TECHNIQUES FOR DOWNLINK AND UPLINK COEXISTENCE IN WIRELESS NETWORK SYSTEMS

(71) Applicant: QUALCOMM Incorporated, San Diego, CA (US)

(72) Inventors: Varun Amar Reddy, San Diego, CA (US); Sony Akkarakaran, Poway, CA (US)

(21) Appl. No.: 19/185,768

(22) Filed: Apr. 22, 2025

(51) Int. Cl. H04W 72/0446; H04W 52/02; H04W 72/21; H04W 72/232

(52) U.S. Cl. CPC H04W 72/0446; H04W 52/0203; H04W 72/21; H04W 72/232

(57) ABSTRACT

This disclosure provides systems, methods, and devices wireless systems that support enhanced scheduling techniques for downlink and uplink positioning determination coexistence. In a first aspect, a device for wireless communication includes at least one processor and a memory coupled to the at least one processor. The at least one processor is configured to cause the device to receive schedule information for a position services wireless system, wherein the schedule information indicates a schedule that satisfies a maximum transmission gap constraint between transmission and reception slots of a cycle for scheduled devices; transmit a first transmission during a first transmission slot indicated by the schedule information; and receive a second transmission during a first reception slot indicated by the schedule information, wherein the device is awake and in an idle mode between the first transmission slot and the first reception slot. Other aspects and features are also claimed and described.

### TECHNICAL FIELD

Aspects of the present disclosure relate generally to wireless communication systems, and more particularly, to wireless network systems that provide positioning-based services. Some features may enable and provide improved scheduling schemes for downlink and uplink coexistence, including device or group scheduling with reduced idle times between transmission and reception.

### INTRODUCTION

In general, warehouses and retail stores use paper labels to display information about products stored or displayed on shelves, such as name, count, prices, discount rates, unit costs, origins, or the like. Using such paper labels for the price display has limitations. For example, when there are changes in product information or locations on shelves, the warehouse or retailer must generate new paper labels and discard old ones and/or move labels around. This raises costs for maintenance in both supplies and employee labor. Further, in environmental terms, replacing the labels wastes raw materials such as paper, which adversely affects the protection of the environment. Still further, humans are prone to make mistakes, such as mislabeling a shelf or product or forgetting to take down temporary price changes on certain shelving, which results in shopper frustration.

Instead, electronic devices can be used for displaying information for items stored in warehouses, retail stores, etc., and may be used in place of paper labels. These electronic devices, electronic label devices or simply electronic labels, may be attached to infrastructure near an asset or assets and display a variety of information using one or more display devices, such as Liquid Crystal Displays (LCD). Whenever the information about a product or the location of a product is changed, the electronic label device may be programmed with new product information. Thus, the electronic label device can be repeatedly used.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Electronic label devices may be used in a wireless network to provide information and services to employees and shoppers (as users of a wireless system). For example, electronic label devices operating on a wireless network as part of wireless system (electronic label system) may support position location services to identify the location of electronic label devices within an environment (e.g., a warehouse or a retail store). As another example, the electronic label system may support position location services to identify a position of users within the environment by interacting with the user's mobile device, non-system devices.

Example embodiments provide for enhanced scheduling techniques for downlink and uplink positioning coexistence operations which enable a more flexible and adaptable scheduling scheme that can reduce power consumption when utilizing both uplink and downlink position determination techniques. The enhancements may utilize a maximum idle time between transmission and reception operations for devices that reduces power consumption for scheduling the transmission and reception operations in an uplink and/or downlink positioning coexistence system/network. For example, the maximum idle time may correspond to an amount of time where a device staying in idle mode between consecutive, scheduled reception and transmission slots consumes less power than switching (e.g., powering down) to a low power mode (a reduced power or sleep mode) and powering back up from the low power mode. Additional techniques, such as semi-static or dynamic updates to the schedule based on adjusted idle times may adapt the system to changes in the system, and techniques such as spatial/frequency reuse and FDMA can be employed to further increase system performance.

In one aspect of the disclosure, a device for wireless communication comprises: at least one processor; and a memory coupled to the at least one processor. The at least one processor is configured to cause the device to: receive schedule information for a position services wireless system, wherein the schedule information indicates a schedule that satisfies a maximum transmission gap constraint between transmission and reception slots of a cycle for scheduled devices; transmit a first transmission during a first transmission slot indicated by the schedule information; and receive a second transmission during a first reception slot indicated by the schedule information, wherein the device is awake and in an idle mode between the first transmission slot and the first reception slot.

In another aspect of the disclosure, a method for wireless communication comprises: receiving schedule information for a position services wireless system, wherein the schedule information indicates a schedule that satisfies a maximum transmission gap constraint between transmission and reception slots of a cycle for scheduled devices; transmitting a first transmission during a first transmission slot indicated by the schedule information; and receiving a second transmission during a first reception slot indicated by the schedule information, wherein the device is awake and in an idle mode between the first transmission slot and the first reception slot.

In an additional aspect of the disclosure, a device for wireless communication comprises: at least one processor; and a memory coupled to the at least one processor. The at least one processor is configured to cause the device to: generate schedule information for a position services wireless system based on a maximum transmission gap constraint; and transmit the schedule information to one or more devices of the position services wireless system, wherein the schedule information indicates a schedule that satisfies a maximum transmission gap constraint between transmission and reception slots of a cycle for scheduled devices.

In another aspect of the disclosure, a method for wireless communication comprises: generating schedule information for a position services wireless system based on a maximum transmission gap constraint; and transmitting the schedule information to one or more devices of the position services wireless system, wherein the schedule information indicates a schedule that satisfies a maximum transmission gap constraint between transmission and reception slots of a cycle for scheduled devices.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

Devices, networks, and systems may be configured to communicate via one or more portions of the electromagnetic spectrum. The present disclosure describes certain aspects with reference to certain communications technologies, such as Bluetooth or Wi-Fi. However, the description is not intended to be limited to a specific technology or application, and one or more aspects described with reference to one technology may be understood to be applicable to another technology. Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus, and methods described herein may be applied to other communications systems and applications than the particular examples provided.

For example, the described implementations may be implemented in any device, system, or network that is capable of transmitting and receiving RF signals according to any of the wireless communication standards, including any of the IEEE 802.11 standards, the IEEE 802.15.1 Bluetooth® standards, Bluetooth low energy (BLE), code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, 5G New Radio (5G NR), 6G, or other known signals that are used to communicate within a wireless, cellular, or internet of things (IOT) network, such as a system utilizing 3G, 4G 5G, or 6G technology, or further implementations thereof.

In various implementations, the techniques and apparatus may be used in wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably and may refer to a collection of devices capable of communicating with each other through one or more communications techniques.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, or packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.).

Implementations may range from chip-level or modular components to non-modular, non-chip-level implementations and further to aggregated, distributed, or original equipment manufacturer (OEM) devices or systems incorporating one or more described aspects. In some settings, devices incorporating described aspects and features may also include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, or constitutions.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a device is described as containing components A, B, or C, the device may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1A is a block diagram illustrating an example electronic label system according to some embodiments of this disclosure.

FIG. 1B is a diagram of an example display of an electronic label according to some embodiments of this disclosure.

FIG. 2A is a perspective view of a gondola with electronic label devices according to some embodiments of the disclosure.

FIG. 2B is a top-down view of a warehouse environment with electronic label devices accessible to a user according to some embodiments of the disclosure.

FIG. 3 is a timing diagram illustrating time division multiplexing for communicating with multiple electronic label devices according to some embodiments of the disclosure.

FIG. 4 is a block diagram illustrating an example electronic label device according to some embodiments of this disclosure.

FIG. 5 is a block diagram illustrating an example wireless communication system that supports enhanced scheduling operations for downlink and uplink positioning coexistence according to one or more aspects.

FIG. 6 is a timing diagram illustrating an example process that supports enhanced scheduling operations for downlink and uplink positioning coexistence according to one or more aspects.

FIG. 7 is a timing diagram illustrating an example process that supports enhanced scheduling operations for downlink and uplink positioning coexistence according to one or more aspects.

FIG. 8 is a timing diagram illustrating an example process that supports enhanced scheduling operations for downlink and uplink positioning coexistence according to one or more aspects.

FIG. 9 is a diagram illustrating an example of an electronic label system that supports enhanced scheduling operations for downlink and uplink positioning coexistence according to one or more aspects.

FIG. 10 is a timing diagram illustrating an example process that supports enhanced scheduling operations for downlink and uplink positioning coexistence according to one or more aspects.

FIGS. 11A-11C are each a diagram illustrating an example of a transmission and reception schedule created in accordance with a maximum transmission gap or idle time that supports enhanced scheduling operations for downlink and uplink positioning coexistence according to one or more aspects.

FIG. 12 is a flow diagram illustrating an example process that supports enhanced scheduling operations for downlink and uplink positioning coexistence according to one or more aspects.

FIG. 13 is a flow diagram illustrating another example process that supports enhanced scheduling operations for downlink and uplink positioning coexistence according to one or more aspects.

FIG. 14 is a block diagram of an example electronic label device that supports enhanced scheduling operations for downlink and uplink positioning coexistence according to one or more aspects.

FIG. 15 is a block diagram of an example wireless device that supports enhanced scheduling operations for downlink and uplink positioning coexistence according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support enhanced scheduling schemes for electronic label device position determination and electronic label device position-based notification operations. The enhanced scheduling schemes for electronic label device position determination operations support both uplink and downlink-based determination of device position within an electronic label system based on electronic label infrastructure, including for both system device (e.g., internal devices) and non-system devices (e.g., external devices). In such systems, system devices (e.g., server(s), AP(s), electronic label devices, IoT tag(s), etc.), or non-system devices (e.g., UEs) can determine a position for the non-system devices and/or eTags (electronic tags) based on electronic label device system wireless transmissions. The present disclosure also supports enhanced scheduling operations for downlink and uplink positioning coexistence that enable the electronic label device system to modify downlink and/or uplink positioning operations to improve utilization and reduce power consumption. For example, a transmission schedule or schedule change may be determined for the electronic label device position determination operations based on a maximum transmission gap between transmission and reception slots for a device or group of devices, where the devices are expected to remain in an idle mode between the transmission and reception slots. By keeping the maximum transmission gap small and tailored to the device's power consumption, the device(s) may consume less power staying in an idle mode as compared to powering down and powering back up between the slots. Accordingly, by scheduling devices to have shorter gaps, devices can complete their UL and DL communications in shorter time span and consume less power. This type of scheduling requires more coordination and processing power to generate and update, and can lead to increased collisions, such as from the unpredictability of exact eTag transmission. However, additional techniques can be used to reduce collisions and improve throughput, such as frequency and spatial reuse, FDMA, transmission probability, etc.

Particular implementations of the subject matter described in this disclosure may be implemented to realize one or more of the following potential advantages or benefits. In some aspects, the present disclosure provides techniques for the determination of schedules for uplink and/or downlink operations based on device power constraints (e.g., maximum idle time) which reduce power consumption and for schedules adjustments to the uplink and/or downlink operations based on the device power constraints. For example, the electronic label device system can modify the schedule of uplink and downlink position determination transmissions to schedule each device or group of devices to have transmission and reception slots that are either adjacent to one another or that are within a transmission gap constraint that saves the devices power. The modified the schedule of uplink and downlink slots with shorter gap times may reduce the overall number of power-up and power-down operations by devices, thereby eliminating some of the power consumption overhead. Thus, the electronic label device system can greatly reduce power consumption when engaging in both UL and DL based positioning operations. In some such aspects, the electronic label device system may be able to further group the electronic label devices and make scheduling modification on a per group, area, and/or frequency basis to further improve the network utilization and power reduction.

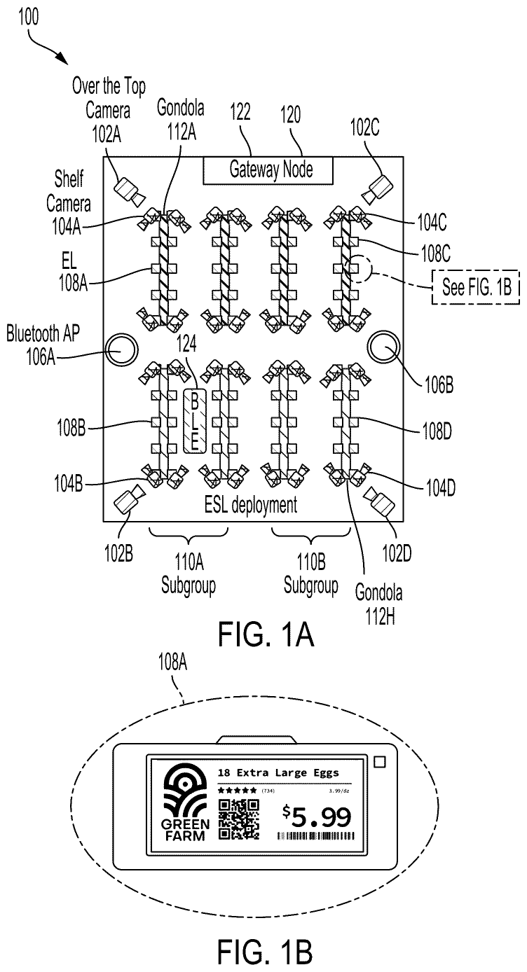

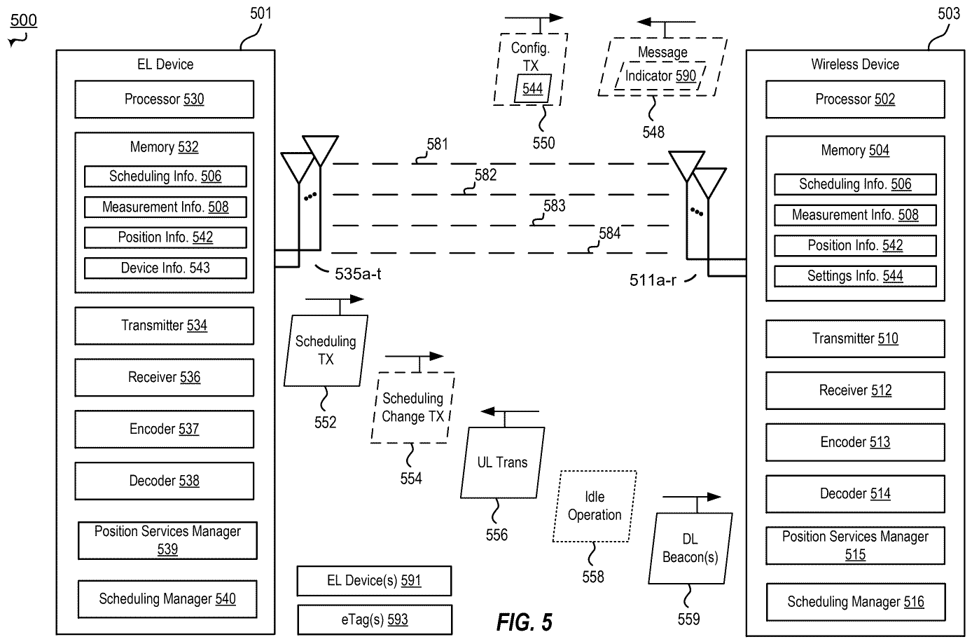

FIG. 1A is a block diagram illustrating an example electronic label device system according to some embodiments of this disclosure. An electronic label device system 100 may include a management server 122 that is integrated with or coupled to a gateway node 120. The management server 122 may include at least one processor coupled to a memory, in which the at least one processor is configured to execute computer program code stored on a computer-readable medium to cause the management server 122 to perform operations related to managing operation of the electronic label device 108A-D, the APs 106A-106B, the gateway node 120, and/or other components within the electronic label device system 100. For example, the management server 122 may perform operations relating to electronic label device-based position determination and/or generation of electronic label device notifications based on electronic label device-based position determinations. For example, the management server 122 may perform enhanced scheduling operations for downlink and uplink positioning coexistence described with reference to FIGS. 5-9.

The gateway node 120 may communicate with access point (AP) 106A and access point (AP) 106B. Although only two APs are shown in the example system, fewer or more APs may be included in the electronic label device system 100. The APs 106A and 106B may communicate through a first communication network, either wired or wireless, with the gateway node 120. The APs 106A and 106B also communicate through a second communication network with electronic label devices and electronic tag devices (e.g., IoT tags). For example, the APs 106A and 106B may communicate with paired electronic label devices in an assigned geographic area. In a first geographic assignment 110A, the AP 106A may communicate with electronic label device 108A and electronic label device 108B; in a second geographic assignment 110B, the AP 106B may communicate with electronic label device 108C and electronic label device 108D. The first and second communication networks may be different networks. In some embodiments, the first communication network for communication between AP 106A and gateway node 120 is a Wi-Fi network and the second communication network for communication between AP 106A and electronic label device 108A is a Bluetooth network.

Bluetooth technology provides a secure way to connect and exchange information between electronic devices, such as smartphones, other cellular phones, headphones, earbuds, smartwatches, laptops, wearables, and/or shelf labels. Bluetooth communications may include establishing wireless personal area networks (PANs) (also referred to as “ad hoc” or “peer-to-peer” networks). These ad hoc networks are commonly called “piconets.” Each device may belong to multiple piconets. Multiple interconnected piconets may be called scatternets. A scatternet may be formed when a member of a first piconet elects to participate in a second piconet. In the example of FIG. 1A, the electronic label device 108A may be in a piconet with the AP 106A.

Because many of the services offered over Bluetooth can expose private data or allow the connecting party to control the connected device, Bluetooth networks may have devices first establish a “trust relationship” before they are allowed to communicate private data to one another. This trust relationship may be established using a process referred to as “pairing,” in which a bond is formed between two devices. This bond enables the devices to communicate with each other in the future without further authentication. The electronic label device 108A may be bonded in such a manner to the AP 106A. The pairing process may be triggered automatically each time the device is powered on or moved within a certain distance of another Bluetooth device. Pairing information relating to current and previously established pairings may be stored in a paired device list (PDL) in the memory of the Bluetooth device, such as the electronic label device 108A and/or the AP 106A. This pairing information may include a name field, an address field, a link key field, and other similar fields (such as “profile” type) useful for authenticating the device or establishing a Bluetooth communication link. The pairing information may allow the electronic label device 108A to reconnect to the AP 106A automatically when, for example, power loss causes the electronic label device system 100 to reset.

A Bluetooth “profile” describes general behaviors through which Bluetooth-enabled devices communicate with other Bluetooth devices. For example, the hands free profile (HFP) describes how a Bluetooth device (such as a smartphone) may place and receive calls for another Bluetooth device, and the Advanced Audio Distribution Profile (A2DP) describes how stereo-quality audio may be streamed from a first Bluetooth device (such as a smartphone) to another Bluetooth device (such as an earbud). The electronic label devices 108A-108D may be configured with one or more profiles compliant with one or more industry standards. In some aspects, a profile may specify how the AP 106A may use one or more electronic label Services exposed by the electronic label device 108A.

The management server 122 may be implemented as a database (DB) server that stores and manages product information regarding products displayed in a distribution store. The management server 122 may store a variety of information used during the operation of a store, as well as product information. Furthermore, the management server 122 may write and manage command messages that are used to carry out various functions such as the synchronization, updating, and alteration of product information displayed on the electronic label devices 108A-108D. The management server 122 may be provided with a database for the electronic label devices 108A-108D and product information displayed on the electronic label devices 108A-108D. That is, the management server 122 may be provided with a database that stores identification information relating to electronic label devices 108A-108D in connection with product information displayed on a corresponding one of the electronic label devices 108A-108D.

A command message, created by the management server 122 (e.g., a product-information change message or a management-information acquisition message) can be transferred to the gateway node using a message packaged into a packet suitable for a communication scheme used with the gateway node 120, and transfer the configured packet. Furthermore, the management server 122 may receive a reception acknowledgement message, sent from the gateway node 120, through the communication scheme, convert the received message into a message receivable by the management server 122, and transfer the converted message. The messages may include notifications of an electronic label device system determined position and/or notification instructions based on such determined positions as described further with reference to FIGS. 5-10.

Although only one gateway node 120 is shown in the electronic label device system 100, there may be several such gateway nodes communicating with the management server 122. Each gateway node 120 analyzes data received from the management server 122 confirming the presence or absence of a message or data, which is to be sent to the electronic label device 108A, and then sends the confirmed message or data to the corresponding electronic label device 108A. The gateway node 120 may configure a message, which is to be sent to the electronic label device 108A, into a packet according to a communication scheme and send the configured packet to the electronic label device 108A through commanding the AP 106A to transmit the packet. Furthermore, the gateway node 120 may transfer a reception acknowledgement message received from the electronic label device 108A through the AP 106A to the management server 122.

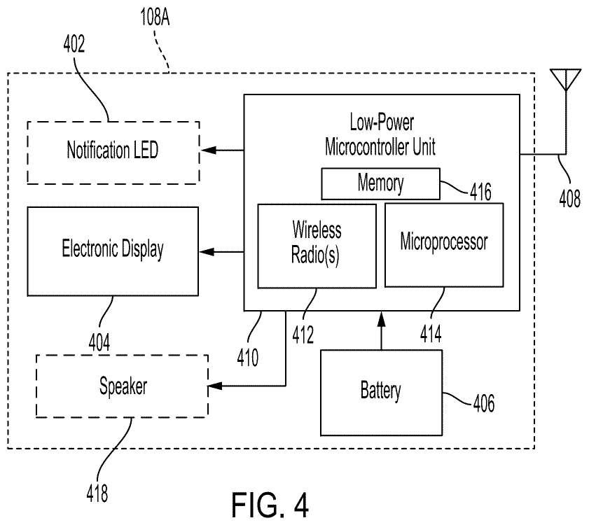

The electronic label devices 108A-108D may include a plurality of electronic label devices 108A-108D displaying data concerning product information received from the gateway node 120. The electronic label devices 108A-D displaying product information associated with products may be attached to the shelving. One example layout of an electronic label device system 100 is shown across multiple gondolas 112A-112H. Each of the gondolas 112A-112H may include one or more shelves, to which the electronic label devices 108A-108D are attached. The electronic label device 108A-108D may be configured as shown, for example, in FIG. 4, with the microcontroller configured to perform operations described with reference to FIGS. 5-16.

In some embodiments, a video monitoring system may be included as part of electronic label device system 100 or used to augment the capabilities of the electronic label device system 100. For example, shelf cameras 104A-104D may be positioned with a field of view that captures one or more shelves of one or more of the gondolas 112A-112H. The shelf cameras 104A-104D may be used to assist in tracking stock levels and/or identifying items picked by users while in the environment. As another example, over-the-top (OTT) cameras 102A-102D may be positioned with a field of view capturing large regions of an environment of the electronic label device system 100. Object recognition systems may be applied to received image frames from the cameras 102A-D or 104A-D to determine a presence of, or count of, objects and humans in the field of view of a respective camera.

The OTT cameras 102A-102D may be used to support determination of a position of an electronic label device 108A-D, user mobile device, or other devices within the environment. A mobile device supporting Bluetooth Low Energy (BLE), such as BLE device 124, may traverse the environment and communicate with the electronic label devices 108A-108D, for example to receive identification information from the electronic label devices 108A-108D, with the location of the electronic label devices 108A-D determined by identifying a location of the BLE device 124 from the camera image frames at the time the BLE device 124 receives signals, and/or the strength of the signals, received from the electronic label devices 108A-108D.

The electronic label devices 108A-108D may change price information or be activated or inactivated while communicating with the gateway node 120. A store manager may send the management server 122 a command concerning the synchronization between a product and the electronic label device 108A and/or a command for the correction of information regarding a product assigned to the electronic label device 108A. An example electronic label device display is shown in FIG. 1B, with such a device displaying information including a product description, a product image, a product price, a product barcode, a product rating, a product Stock Keeping Unit (SKU), and/or a product link (e.g., a URL or QR code).

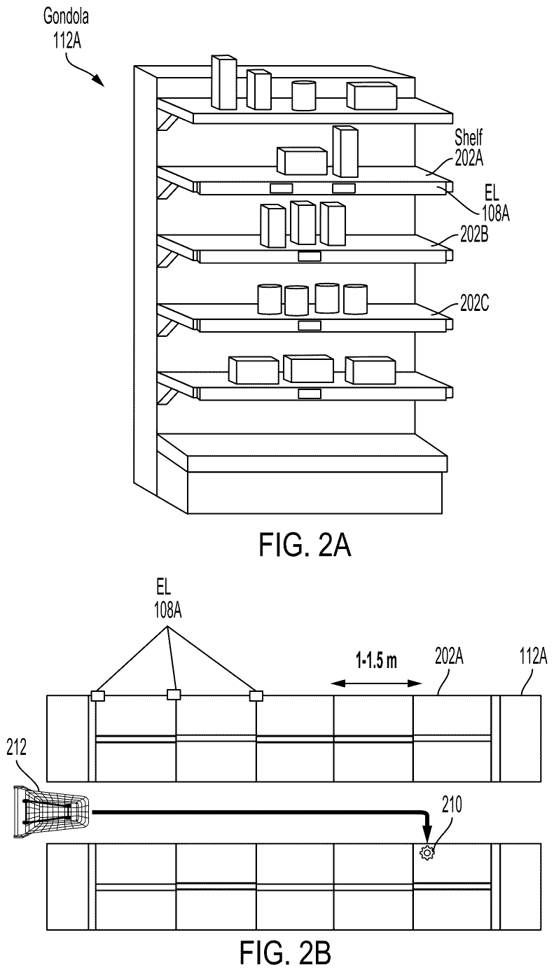

As described earlier, the environment may include electronic label devices organized on gondolas and shelves. One example illustration of such an arrangement is shown in FIG. 2A. FIG. 2A is a perspective view of a gondola with electronic label devices according to some embodiments of the disclosure. The gondola 112A may include multiple shelves 202A-202C at different vertical levels from a floor. electronic label devices may be attached to the shelves 202A-202C. For example, electronic label device 108A may be attached to shelf 202A to display information regarding products stocked on shelf 202A in the vicinity of the electronic label device 108A.

The electronic label devices may provide information to a shopper or store employee operating in the environment, such as to provide information regarding products and/or assist with location determination of products or the user. FIG. 2B is a top-down view of a warehouse environment with electronic label devices accessible to a user according to some embodiments of the disclosure. A user pushing a shopping cart 212 through an aisle may use electronic label devices to determine the location of a particular product. For example, a mobile device associated with the shopping cart 212 may guide a user to location 210 where stock for a desired product is located.

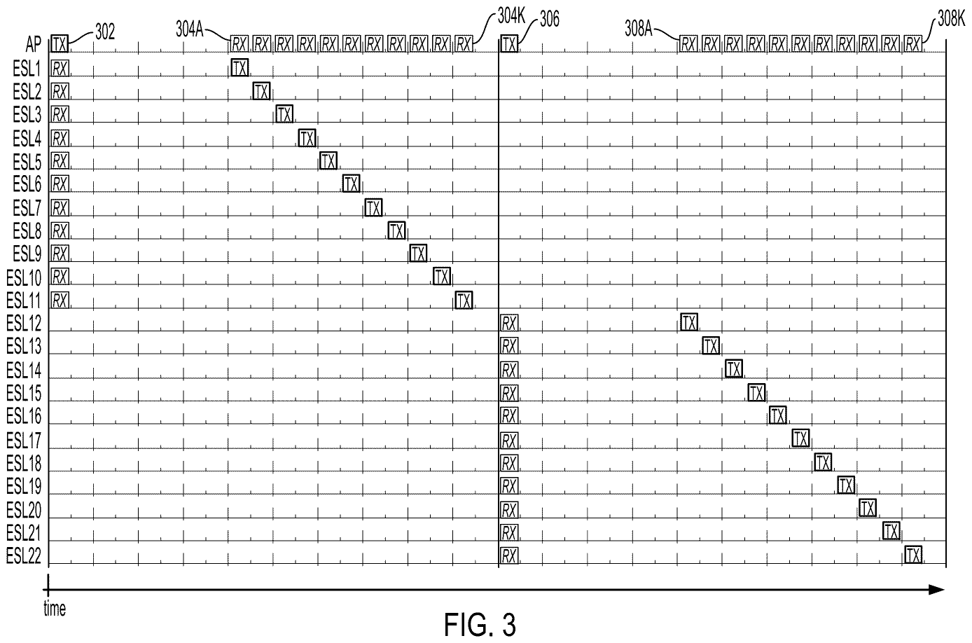

Communication within the electronic label device system 100 between an access point (AP) and electronic label devices may be performed according to a Time Division Multiple Access (TDMA) scheme, such as one illustrated in FIG. 3. FIG. 3 is a timing diagram illustrating time division multiplexing for communicating with multiple electronic label devices according to some embodiments of the disclosure. An AP, such as AP 106A, may broadcast information that is received by all electronic label devices, including electronic label device 108A, during a first time period 302. The electronic label devices may communicate with the AP during subsequent time periods. For example, a first electronic label device, such as electronic label device 108A, may transmit in time period 304A, with other electronic label devices transmitting in time periods 304B-304K. In electronic label device systems with significant numbers of electronic label devices, the electronic label devices may be configured to communicate in different groups. For example, electronic label devices 1-11 may be configured to transmit to the AP during a first time cycle and electronic label devices 12-22 may be configured to transmit to the AP during a second time cycle. The first and second time cycles may alternate during operation of the wireless network.

An electronic label device may include components configured together to provide some or all of the functionality described in this disclosure and/or provide additional functionality. FIG. 4 is a block diagram illustrating an example electronic label device according to some embodiments of this disclosure. The electronic label device 108A may include a low-power microcontroller 410. Although functionality for the electronic label device may be configured by the microcontroller 410 in embodiments of this disclosure, any single or combination of processors (e.g., at least one processor) may be used to perform the functions described according to embodiments of this disclosure.

The microcontroller 410 may include a memory 416. The memory 416 may store computer program code that causes a microcontroller 410 to execute operations that carry out some or all of the functionality described in embodiments of this disclosure. Although shown as part of the microcontroller 410, the memory 416 may be located internal to or external to the microcontroller 410. The microcontroller 410 may also include one or more wireless radio(s) 412. The wireless radios 412 may include, for example, a Bluetooth wireless radio including a front end that couples to antenna 408 for transmitting and receiving radio frequency (RF) signals at one or more frequencies in one or more frequency bands. In some embodiments, the microcontroller 410 is a System on Chip (SoC) in which two or more components of the wireless radio(s) 412, the microprocessor 414, and/or the memory 416 are included in a single semiconductor package. In some embodiments, the two or more components may be included on a single semiconductor die.

The electronic label device 108A may include I/O devices, such as a notification LED 402 and/or an electronic display 404. The notification LED 402 may include one or more light emitting diodes (LEDs), or other light sources configured to flashlight of one or more colors. The notification LED may be triggered to blink at a specific time and/or with a specific color based on a command received from the gateway node 120. For example, a notification LED 402 may blink to attract a user's attention to a particular location on a shelf. The electronic display 404 may be, for example, an electronic-ink (e-Ink) display configured to output the product information. In some implementations, the electronic label device 108A may include a speaker 418. The speaker 418 may include one or more audio output devices configured to output audio signals. For example, the speaker 418 may output tones, beeps, bell or chime sounds, or speech.

The electronic label device 108A may couple to a battery 406 or other power source to power operations performed by the electronic label device 108A, such as to operate the wireless radio(s) 412, the notification LED 402, the electronic display 404, the memory 416, the speaker 418, and/or the microprocessor 414. The battery 406 may allow placement of the electronic label device 108A in a place where constant power supply is difficult. Thus, in order that a single battery charge provides a long period of use (e.g., lasting longer than several years), the electronic label device 108 may be configured to reduce power consumption during times when frequent commands are not expected. For example, the electronic label device 108A may operate using a wakeup communication scheme. That is, the electronic label device 108A wakes up according to predetermined time intervals to determine whether data is waiting to be received. When no data is waiting, power to the electronic label device 108A is turned off until the next wakeup period to reduce power consumption. When there is data to be received, the electronic label device 108A wakes up to perform communication operations.

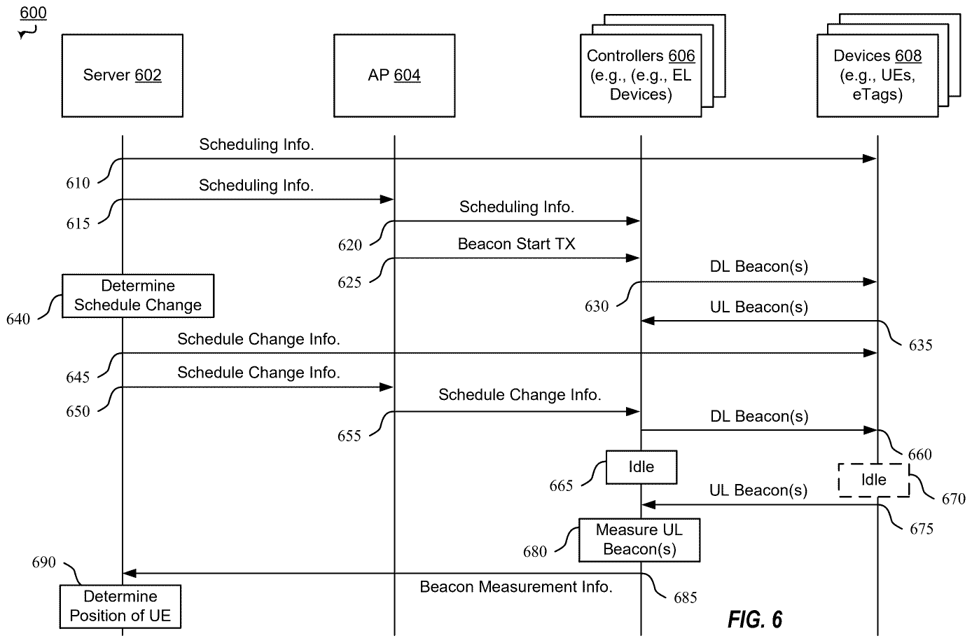

It is noted that one or more blocks (or operations) described with reference to FIGS. 1A-4 may be combined with one or more blocks (or operations) described with reference to another of the figures. For example, one or more blocks (or operations) of FIG. 5 may be combined with one or more blocks (or operations) of FIGS. 1A-4. As another example, one or more blocks associated with FIG. 6 may be combined with one or more blocks associated with FIGS. 1A-4.

In certain scenarios, only Received Signal Strength Indicator (RSSI) measurements can be obtained by a device to estimate its position. Some examples of such scenarios include position estimation for or by low-cost devices or anchor node infrastructure which cannot perform other more complex measurements, such as more advanced strength or quality measurements, angle or arrival (AoA) measurements, or time of arrival (TOA) measurements that require advanced processing capability or hardware. Electronic label system infrastructure is one such example and presents a highly-dense network of anchor nodes that can achieve sub-meter accuracy in warehouse and retail-store settings, albeit with constraints on power consumption, because they are often battery-powered.

Downlink (DL)-based positioning schemes can be used to enable position determination for mobile devices based on beacons from electronic label system infrastructure. Such a scheme is compatible with mobile devices that are capable of decoding the system beacons and measuring their RSSI. However, in order to determine a position for ambient IoT energy-harvesting eTags, which cannot decode the beacons, a different uplink (UL)-based positioning determination approach may be required where the wireless radios of the electronic label system infrastructure wake up to receive beacons from the eTags. To serve both types of devices (e.g., smartphones and eTags), a combination of both DL and UL schemes would have to be deployed. However, catering to both DL and UL positioning determining schemes would result in increased power consumption and lower battery life at the electronic label devices.

In the aspects described herein, enhanced scheduling techniques for reducing power consumption in such a DL and UL coexistence scenarios are described. In some aspects, an electronic label system may schedule devices or groups of devices to transmit and receive in close proximity to one another in time such that a device can remain in an idle mode. For example, a device, group of devices, or all devices may be scheduled to transmit and receive in adjacent slots or withing ‘X’ number of slot from one another to prevent power consumption from power-down and power-up operations. To illustrate, the electronic label system may schedule one or more devices of the system to both transmit and receive within a time period where staying in an idle mode consumes less power than powering-down and powering back up.

A base or fixed schedule (e.g., a static or semi-static schedule) for normal operation for multiple or all time slots or cycles may be determined based on the above time scheduling constraint for power saving in some aspects. Additionally, or alternatively, an adjusted schedule (e.g., semi-static or dynamic schedule) for multiple time slots or cycles or for a single time slot or cycle may be determined based on the above time scheduling constraint for power saving in some aspects.

In some such aspects, the schedule (e.g., scheduling information indicates) for one or more devices of the electronic label system includes one or more common DL slots or one or more common UL slots. For example, a common DL slot-based schedule may correspond to a schedule that includes a particular downlink slot or downlink slots (e.g., slot 4 or slots 5 and 6) that is always used for DL transmissions (e.g., beacons from electronic label system anchor nodes), and that includes an UL slot or slots for particular devices (e.g., UEs or eTags) that interact with the electronic label system that are within x amount of time or amount of slots from the common DL slot or slots (e.g., within slots 3 or 5, when the common DL slot is slot 4 and the time period is 1 time slot). Thus, the battery-powered anchor devices (e.g., electronic label devices) of the electronic label system may remain in an idle mode between transmission during the DL slots and reception during the UL and save power because the idle mode is kept short, or short enough that the length of time spent in the idle mode consumes less power than powering down and powering back up.

As another example, a common UL slot-based schedule may correspond to a schedule that includes a particular uplink slot or uplink slots (e.g., slot 4 or slots 5 and 6) that is always used for UL transmissions (e.g., beacons from UEs or eTags), and that includes a DL slot or slots for particular devices (e.g., electronic label devices/anchor devices) of the electronic label system that are within x amount of time or amount of slots from the common UL slot or slots (e.g., within slots 2, 3, 5, or 6, when the common UL slot is slot 4 and the time period is 2 time slots). Thus, the battery-powered wireless devices (e.g., UEs) that interact with the electronic label system may remain in an idle mode between transmission during the UL slots and reception during the DL and save power because the idle mode is kept short, or short enough that the length of time spent in the idle mode consumes less power than powering down and powering back up.

Additionally, in the aspects described herein other enhanced scheduling techniques for reducing power consumption in DL and UL coexistence scenarios are described. Spatial information, device-specific power constraints, FDMA, and/or frequency reuse aspects may be used to determine the schedule information or adjustments to the schedule information to further improve throughput and power savings. For example, using FMDA to schedule the time slots of the electronic label system may improve throughput and further enable reduced power consumption by enabling more devices to be scheduled a DL slot (e.g., TX or RX operation) closer to an UL slot (e.g., TX or RX operation). Similarly, spatial geometry and frequency reuse may be used to improve throughput and further enable reduced power consumption by enabling more devices to be scheduled a DL slot (e.g., TX or RX operation) closer to an UL slot (e.g., TX or RX operation. As another example, device specific power constraints and/or scheduling based on current batter power may enable the electronic label system to further reduce power consumption, including for devices low on power resources, and to support a power savings by more devices (e.g., low and high complexity devices, multiple types of devices, devices in different modes, etc.).

FIG. 5 illustrates an example of a wireless communications system 500 that supports enhanced scheduling operations for downlink and uplink positioning coexistence and electronic label position-based notification operations in accordance with aspects of the present disclosure. In some examples, the wireless communications system 500 may implement aspects of electronic label device system 100. For example, the wireless communications system 500 may include an electronic label device system network, such as electronic label system infrastructure including one or more electronic label devices or network entities, and one or more wireless devices which interact with the electronic label system infrastructure. The wireless devices may include UEs and/or eTags. As illustrated in the example of FIG. 5, the wireless communications system 500 includes an electronic label device 501 and a wireless device 503.

The electronic label device 501 may include or correspond to any of the electronic label devices or infrastructure described herein, including the gateway node 120, the management server 122, an electronic label system AP (e.g., the AP 106A or 106B), an electronic label device or controller (e.g., electronic label devices 108C or 108D), or the electronic label device 400 of FIG. 4. An electronic label device controller may include one or more electronic label devices and a wireless radio and be referred to as an electronic label rail controller or more simply an electronic label controller.

The wireless device 503 may include or correspond to a UE that interacts with electronic label system infrastructure, or to a second electronic label system device. The UE may be part of the electronic label system infrastructure or separate from the electronic label system infrastructure. For example, the UE may be associated with a worker or a robot, or with a customer/shopper. The second electronic label system device may include any of the electronic label system devices of electronic label device 501 and may include or correspond to a different type of electronic label device from the electronic label device 501. As illustrative, non-limiting examples, the electronic label device 501 may include or correspond to an electronic label controller associated with one or more electronic label devices and the wireless device 503 may include or correspond to an electronic label system AP, an electronic label system server, or an IoT tag associated with a product or asset of the electronic label system network.

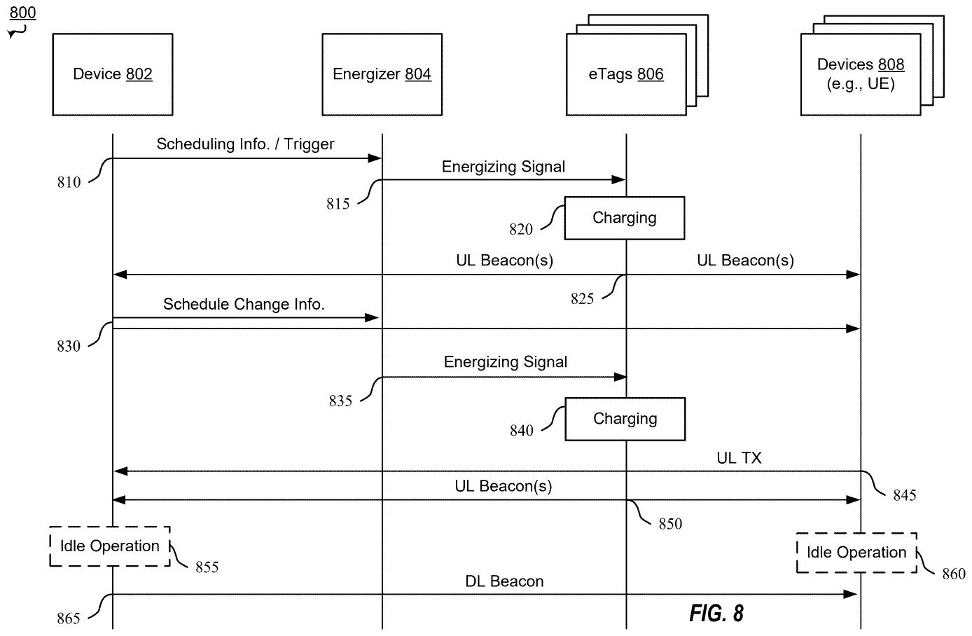

As illustrated in the example of FIG. 5, the wireless communications system 500 may further include one or more electronic label devices 591 (e.g., second electronic label devices), one or more electronic tags (eTags) 593 (e.g., IoT tags). The one or more electronic label devices 591 may include or correspond to an electronic label device which is the same type as or a different type from a type of the electronic label device 501, a type of the wireless device 503, or both. The eTags 593 may include or correspond to passive or battery-less radios which may output a signal or beacon based on received RF energy. The eTags 593 may be coupled to or associated with one or more products or assets of the electronic label device system. In a particular implementation, the one or more electronic label devices 591 may include an energizer device configured to provide RF energy to the eTags 593 and/or trigger the eTags 593 to broadcast beacons for measurement, as described further with reference to FIG. 8.

Enhanced scheduling operations for downlink and uplink positioning coexistence may reduce power consumption and provide additional throughput and adaptability for the electronic label system network and devices which interact with the electronic label system network. For example, enhanced scheduling operations for downlink and uplink positioning coexistence may enable the electronic label system to more tightly group transmission and reception slots to reduce gap or idle times and/or to conserve power by optionally refraining from powering save operations (e.g., power consumption from powering down and powering back up. Accordingly, electronic label system network and device performance can be increased.

Electronic label device 501 and wireless device 503 may be configured to communicate via one or more portions of the electromagnetic spectrum. For example, the electronic label device 501, the wireless device 503, or both, may be configured to communicate via one or more portions of the electromagnetic spectrum associated with Bluetooth transmissions, Wi-Fi transmissions, or cellular transmissions (including sub-6 GHz and 6 GHz).

Electronic label device 501 and wireless device 503 may be configured to communicate via one or more channels or component carriers (CCs), such as representative first channel 581, second channel 582, third channel 583, and fourth channel 584. Although four channels are shown, this is for illustration only, more or fewer than four channels may be used. One or more channels may be used to communicate control channel transmissions, data channel transmissions, and/or sidelink channel transmissions.

Each channel or CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more channels or CCs may have or be assigned to a Cell ID, or a Bandwidth Part (BWP) ID. The Cell ID may include a unique cell ID for the channel or CC, a virtual Cell ID, or a particular Cell ID of a particular channel or CC of the plurality of channels or CCs. Additionally, or alternatively, one or more channels or CCs may have or be assigned to a HARQ ID. Each channel or CC may also have corresponding management functionalities, such as, beam management or BWP switching functionality. In some implementations, two or more channels or CCs are quasi co-located, such that the channels or CCs have the same beam and/or same symbol.

In some implementations, control information may be communicated via electronic label device 501 and wireless device 503. For example, the control information may be communicated using Bluetooth transmissions, Wi-Fi transmission, MAC-CE transmissions, RRC transmissions, DCI (downlink control information) transmissions, UCI (uplink control information) transmissions, SCI (sidelink control information) transmissions, another transmission, or a combination thereof.

Wireless device 503 can include a variety of components (e.g., structural, hardware components) used for carrying out one or more functions described herein. For example, these components can include processor 502, memory 504, transmitter 510, receiver 512, encoder, 513, decoder 514, position services manager 515, scheduling manager 516, and antennas 511a-r. Processor 502 may be configured to execute instructions stored at memory 504 to perform the operations described herein. In some implementations, processor 502 includes or corresponds to the microcontroller 410 and/or the microprocessor 414 of FIG. 4, and memory 504 includes or corresponds to the memory 416 of FIG. 4. Memory 504 may also be configured to store scheduling information 506, measurement information 508, position information 542, settings information 544, or a combination thereof, as further described herein.

The scheduling information 506 includes or corresponds to data associated with or corresponding to transmission timing information of the wireless communications system 500. For example, the scheduling information 506 may include data indicating or identifying transmission windows, such as UL and/or DL slots (e.g., TX and RX slots), transmit opportunities or both. The scheduling information 506 may optionally include grant information, such as transmission grants. The scheduling information 506 may indicate a base scheduling scheme, such as a fixed or semi-static scheme that is configured on start-up, pre-programmed, configured on association, and/or periodically updated for multiple cycles. The base scheduling scheme may be adjusted from time to time by updated schedules or adjustments thereto. The base scheduling scheme may be created in accordance with a maximum transmission gap or device idle length constraint, and/or it may be updated based on a maximum transmission gap or device idle length constraint or one or more different maximum transmission gap or device idle length constraints.

In some aspects, the scheduling information 506 includes or corresponds to schedule change information which represents adjustments to a base scheduling scheme. The schedule change information may indicate a dynamic or semi-static scheme that is periodically updated for one or more cycles. The schedule change information may be indicated differentially from the base schedule (e.g., by a delta or adjustment of slots) or may be indicated by a full explicit, indication (e.g., device group 1 transmit on slot X and receive on slot Y).

The schedule change information includes or corresponds to data associated with or corresponding to a change in the transmission timing identified in the scheduling information 506. For example, the schedule change information identifies one or more UL slots for UL transmissions, one or more DL slots for DL transmission, a maximum transmission gap or device idle length constraint, frequency resources or any combination thereof. The schedule change information may optionally include grant information, such as a modified transmission grant or a new transmission grant that correspond to a previous transmission resource associated with another device, such as an eTag. The wireless device may determine one or more transmission slots (e.g., UL or DL slots depending on the device type), one or more reception slots (e.g., UL or DL slots depending on the device type), and an idle period based on the scheduling information 506.

The measurement information 508 includes or corresponds to data associated with or corresponding to measurements of wireless signals of the wireless communications system 500. For example, the measurement information 508 may include measurement data or measurement values associated with transmissions (e.g., Bluetooth or Wi-Fi transmissions) of the wireless communications system 500 and may enable the generation of position/location information. The measurement information 508 may include signal strength or quality measurements, such as reference signal received power (RSRP), reference signal received quality (RSRQ), RSSI, etc. Additionally, or alternatively, the measurement information 508 may include one or more of directionality information, such as AoA, timing information, such as TOA, or beam information. The measurement information 508 may be used to generate the position information 542. In some aspects, the measurement information 508 is reported to the network (e.g., a system server), and the network derives or calculated the position information 542 based on the measurement information 508. In other aspects, the wireless device 503 derives or calculated the position information 542 based on the measurement information 508 and reports the position information 542 to the network. The network and/or the device may use the position information 542 to engage in or provide a position location service (e.g., notification for an asset or location, directions to an asset or location, etc.).

The position information 542 includes or corresponds to data associated with or corresponding to a position an electronic label device, such as one of electronic label devices 591 or eTags 593, a position of a non-electronic label device, such as wireless device 503, or both. For example, the position information 542 may include data which indicates or identifies a position of a non-electronic label device. To illustrate, the position information 542 may include positioning information or position location information which indicates a position of the device, i.e., position information, or positioning information which may be used to derive the position of the device, such as measurement information 542. The position information 542 may enable the generation of notification requests or notifications (e.g., notification information, indications and/or instructions).

The settings information 544 includes or corresponds to data associated with enhanced position determination operations and/or enhanced position-based notification operations. The settings information 544 may include one or more types of enhanced position determination operation modes and/or enhanced position-based notification operation modes and/or thresholds or conditions for switching between such enhanced modes and/or configurations thereof. For example, the settings information 544 may have data indicating different thresholds and/or conditions for different enhanced position determination modes and/or enhanced position-based notification modes, or a combination thereof.

In some aspects, the settings information 544 includes a device specific maximum idle time length for conserving power, such as for conserving power as compared to powering down and back up. Additionally, or alternatively, the settings information 544 includes device specific power consumption information for one or more of a power down operation, a power up operation, an idle mode operation, etc. The wireless device 503 may report any of this device specific power related information to the network to enable the network to generate schedule information with device or group specific transmission gap constraints that conserve power.

Additionally, or alternatively, the settings information 544 includes asset information, electronic label device information, gondola information, store information, transmission timing information (e.g., beacon timing information), UL and/or DL position determination modes, associated UE information, or a combination thereof.

Transmitter 510 is configured to transmit data to one or more other devices, and receiver 512 is configured to receive data from one or more other devices. For example, transmitter 510 may transmit data, and receiver 512 may receive data, via a network, such as a wired network, a wireless network, or a combination thereof. For example, wireless device 503 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 510 and receiver 512 may be replaced with a transceiver. Additionally, or alternatively, transmitter 510 or receiver 512 may include or correspond to one or more components of electronic label device 108A described with reference to FIG. 4.

Encoder 513 and decoder 514 may be configured to encode and decode data for transmission. Position services manager 515 may be configured to perform enhanced downlink and uplink positioning coexistence operations. For example, the ESL manager 515 may be configured to manage one or more system services, such as to generate system position-based requests and process system notifications based on system-based positions. The position services manager 515 may be configured to generate position-based requests or request information based on measurement information, position information, time information, or a combination thereof.

The position services manager 515 may be configured to perform measurement and position determination operations. For example, the position services manager 515 may be configured to measure system transmissions (e.g., beacons) and determine measurement information based on system information and transmissions. As another example, the position services manager 515 may be configured to determine one or more positions of itself or other devices based on measurements of beacons and/or reference signal(s), the measurement information. Additionally, the position services manager 515 may be configured to determine position or location information of other electronic label devices from system transmissions. The position information may be used to determine notification information.

In some implementations, the position services manager 515 may include or correspond to a measurement manager may be configured to perform position measurement and management operations. For example, the measurement manager may be configured to measure received reference signals or beacons (e.g., beacons and/or beacon responses) to determine wireless information, measurement information, or both. The measurement information may be used to determine position information, such as position information 542.

Scheduling manager 516 may be configured to perform scheduling operations for the position service operations. For example, the scheduling manager 516 may be configured to perform scheduling determination operations based on received scheduling information 506. To illustrate, the scheduling manager 516 may be configured to determine a schedule for itself and/or one or more devices of the system based on scheduling information 506, such as parsing the scheduling information 506. The scheduling manager 516 may also utilize the scheduling information 506 to determine when and how to perform position determination operations, such as transmissions and/or receptions for UL and/or DL-based position determination operations. In some aspects, the scheduling manager 516 may generate or adjust the scheduling information 506, as further described below with reference to scheduling manager 540.

In some aspects, the position services manager 515 or the scheduling manager 516 may be configured to determine a maximum idle length constraint for the wireless device 503 or to determine information which may indicate the maximum idle length constraint for the wireless device 503. For example, the position services manager 515 or the scheduling manager 516 may generate and/or report information regarding power consumption during an idle mode, during a power down operation, during a power save mode, during a power up operation, or any combination thereof. Such information may be referred to as device information, such as device information 543, or settings information 544, and may be provided to the electronic label system in an UL transmission or transmissions.

Although one wireless device (i.e., wireless device 503) is shown in the example of FIG. 5, in other implementations the network may include additional wireless devices which interact with the ESL infrastructure (e.g., electronic label device 501). The other wireless device or devices may include one or more elements similar to wireless device 503. In some implementations, the wireless device 503 and the other wireless device or devices are different types of UEs. For example, either UE may be a higher quality or have different operating constraints. To illustrate, one of the UEs may have a larger form factor or be a current generation device, and thus have more advanced capabilities and/or reduced battery constraints, higher processing constraints, etc. As another example, one UE may be associated with a person and the other UE may be associated with a robot or autonomous device.

Electronic label device 501 includes processor 530, memory 532, transmitter 534, receiver 536, encoder 537, decoder 538, position services manager 539, scheduling manager 540, and antennas 535a-t. Processor 530 may be configured to execute instructions stores at memory 532 to perform the operations described herein. In some implementations, processor 530 includes or corresponds to low-power microcontroller 410 and/or microprocessor 414, and memory 532 includes or corresponds to memory 416 of FIG. 4. Memory 532 may be configured to store schedule information 506, measurement information 508, position information 542, device information 543, settings information 544, transmission probability information, or a combination thereof, and optionally other information such as described with reference to the wireless device 503 and as further described herein.

The device information 543 includes or corresponds to data associated with or corresponding to a device of system devices, such as an electronic label device, an eTag, or a wireless device (e.g., UE/mobile device). For example, the system may include device information 543 for each device of the system and/or associated with the system, such as system and non-system devices. Each device may be associated with a device identifier, and the device information fields or categories may be associated with the device identifier of the device. The device information 543 may include information (e.g., field or category information) indicating battery power, operating mode, type of device, capability information, priority level, active request, service, etc. The device information 543 may be used to determine the schedule information 506 (e.g., the schedule change information thereof), as described further herein. To illustrate, the device information 543 may indicate a maximum idle length constraint or the maximum idle length constraint may be derived from the device information 543.

In some aspects, the device information 543 includes device group information. The device group information may include or correspond to data associated with or corresponding to a group of system devices, such as a group of electronic label devices, a group of eTags, a group of wireless devices (e.g., UEs/mobile devices), or any combination thereof. For example, each device of the system and/or associated with the system, such as system and non-system devices, may be associated with a device identifier, and the device group information may associate a subset of the devices together by device identifier to form a device group and having a device group identifier. The device group information may be used to determine the schedule information 506 (e.g., the schedule change information thereof), as described further herein.

The device group information may be generated and/or adjusted by the server based on one or multiple parameters or conditions. For example, device group information may be generated and/or adjusted by measurement information 508, position information 542, device information 543 (e.g., battery power, operating mode, type of device, capability information, priority level, active request, service, etc., thereof), error or interference information, or any combination thereof.

Additionally, or alternatively, the device information 543 includes transmission probability information. The transmission probability information includes or corresponds to data associated with or corresponding to a likelihood of a device transmitting during a particular time period or for a particular transmit opportunity. The time period may include or correspond to a particular window or slot thereof. For example, the transmission probability information may correspond to a likelihood of an eTag or eTags transmitting during a particular UL slot or slots. The transmit opportunity may be associated with time resources, frequency resources, and/or a coding parameter. When determining a likelihood of a transmission during a transmit opportunity, the electronic label device 501 may also take into account frequency resource and coding (e.g., orthogonality) when determining if transmissions are likely to collide or cause interference (e.g., occupy the transmit resources). Additionally, the transmission probability information may take into account spatial resource, such as the location and/or direction of the transmissions to determine the probability. The transmission probability information may be expressed as a percentage and may optionally include a confidence value. The transmission probability information may be used to determine the schedule change information as described further herein.

Transmitter 534 is configured to transmit data to one or more other devices, and receiver 536 is configured to receive data from one or more other devices. For example, transmitter 534 may transmit data, and receiver 536 may receive data, via a network, such as a wired network, a wireless network, or a combination thereof. For example, UEs and/or electronic label device 501 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 534 and receiver 536 may be replaced with a transceiver. Additionally, or alternatively, transmitter 534 or receiver 536 may include or correspond to one or more components of electronic label device 108A described with reference to FIG. 4.

Encoder 537, and decoder 538 may include the same functionality as described with reference to encoder 513 and decoder 514, respectively. Position services manager 539 may be configured to perform enhanced position-based operations, and may include similar functionality as to the position services manager 515. For example, the position services manager 539 may be configured to determine, configure, and/or coordinate electronic label device system operations, including UL and DL-based position determination operations.

The position services manager 539 may be configured to obtain initial electronic label device position information indicating device positions of electronic label devices, to generate and distribute system configuration or setup information, to transmit beacon start transmissions and/or beacon transmission, to generate or relay schedule change information for the electronic label device system, or a combination thereof. As another example, the position services manager 539 may be configured to determine based positions for electronic label devices or system assets and non-electronic label devices and/or determine notifications based on determined positions.

In some implementations, the position services manager 539 may be configured to generate notifications or notification information based on measurement information, position information, request information, time information, or a combination thereof. The position services manager 539 may include a notification manager configured to perform notification determination and management operations. For example, the notification manager may be configured to generate and/or transmit enhanced notifications, such as notifications based determined positions. The notification manager may be configured to determine notifications for assets, determine when and how to send the determined notifications, determine whether to send the determined notifications, or a combination thereof. Additionally, the notification manager may be configured to generation instructions for causing other electronic label devices and/or UEs to output notifications, such as visual or auditory outputs, to provide a notification, such as directions, to a user or a UE. In some implementations, the notification manager may include a notification filter configured to filter the generation and/or transmission of notifications.

Scheduling manager 540 may include similar functionality as described with reference to the scheduling manager 516. For example, the scheduling manager 540 may be configured to perform scheduling determination operations. To illustrate, the scheduling manager 540 may be configured to determine a schedule (e.g., generate scheduling information 506) for one or more devices of the system based on device information 543. The scheduling manager 540 may also utilize the schedule information to determine when and how to perform position determination operations, such as transmissions and/or receptions for UL and/or DL-based position determination operations.

In some aspects, the scheduling manager 540 may be configured to adjust a schedule of operations to support both UL and DL-based position determination operations and maximum transmission gap constraints. In some aspects, the scheduling manager 540 is configured to determine a device idle power length constraint, and to determine the maximum transmission gap constraint based on the device idle power length constraint.

During operation of wireless communications system 500, the network (e.g., electronic label device 501) may determine that wireless device 503 has position determination and/or position-based notification capability. For example, wireless device 503 may transmit a message 548 that includes an electronic label system position determination and/or electronic label system position-based notification indicator 590 (e.g., an enhanced downlink and uplink positioning coexistence indicator). Indicator 590 may indicate electronic label system position determination and/or electronic label system position-based notification capability for one or more communication modes, such as uplink, downlink, sidelink, etc. In some implementations, an electronic label device system network entity (e.g., the electronic label device 501) sends control information to indicate to the wireless device 503 that enhanced electronic label system position determination coexistence operations and/or a particular type of enhanced electronic label system position determination coexistence operation is to be used. For example, in some implementations, configuration transmission 550 is transmitted to the wireless device 503. The configuration transmission 550 may include or indicate to use enhanced electronic label system position determination coexistence operations or to adjust or implement a setting of a particular type of enhanced electronic label system position determination coexistence operation. For example, the configuration transmission 550 may include schedule information 506 or settings information 544.

During operation, devices of wireless communications system 500 perform enhanced downlink and uplink positioning coexistence operations. For example, the electronic label device system network and wireless devices may exchange transmissions via uplink, downlink, and/or sidelink communications over the communication links and engage in enhanced electronic label system position determination coexistence operations, as illustrated in the example of FIG. 5. Enhanced electronic label system position determination coexistence operations enable improved flexibility and utilization of resources, such as uplink resources, and the ability to use both uplink and downlink-based position determination operations. The enhanced electronic label system position-based notification operations enable electronic label devices and/or wireless devices to have reduced power consumption through utilization of additional uplink resources and reducing redundant downlink operations.

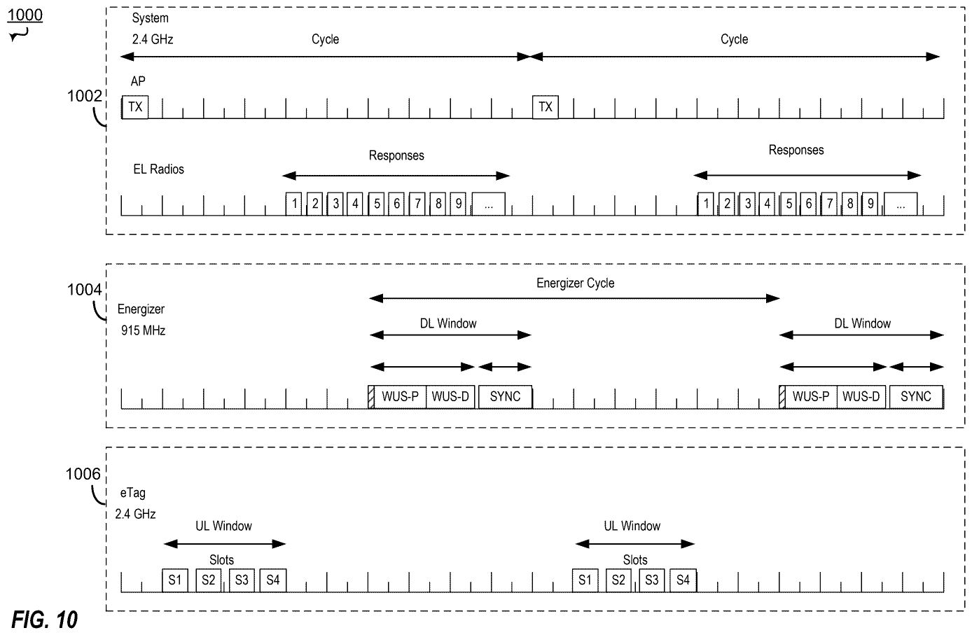

In the example of FIG. 5, the electronic label device 501 generates the scheduling information 506 for transmission in a configuration, timing, or scheduling transmission, such as scheduling information transmission 552. For example, the electronic label device 501 may generate overall electronic label system timing related parameters and information for scheduling beacon transmissions, including for scheduling or performing DL and UL-based position determination operations. To illustrate, the electronic label device 501 may generate timing information relative to beacon start transmissions and/or energizing transmissions, such that the receiving devices can utilize this information along with received trigger transmissions to determine when to transmit, and may generally provide the information for uplink and downlink transmission timing schemes such as described with reference to FIG. 3 and further with reference to FIG. 10.

Additionally, or alternatively, the scheduling information 506 may include one or more UL or DL grants from one or more devices that are associated with the electronic label device system. The scheduling information 506 may be transmitted in multiple ways in some aspects. For example, the scheduling information 506 may be transmitted via a local wireless network or protocol (e.g., Wi-Fi or Bluetooth) to electronic label devices and may be transmitted via another network or protocol (e.g., cellular) to non-electronic label devices. In other examples, the scheduling information 506 may be transmitted via the local wireless network or protocol (e.g., Wi-Fi or Bluetooth) to electronic label system devices and non-electronic label system devices.

In some aspects, the scheduling information 506 is generated in accordance with or based on a maximum transmission gap constraint. The maximum transmission gap constraint may correspond to a maximum idle length gap constraint that results in power savings as compared to performing a power save operation. A schedule generated in accordance with or based on a maximum transmission gap constraint has scheduled transmission slots for a particular device which are no more than X number of slots from scheduled reception slots for the particular device.

As illustrated in the example of FIG. 5, the electronic label device 501 transmits the scheduling information transmission 552, including the scheduling information 506, via wireless transmission to one or more electronic label device, one or more non-electronic label devices, or a combination thereof. Examples of scheduling information 506 generation and transmission are described further with reference to FIGS. 6-10, and may include a server, AP, or controller receiving electronic label system-based position information from and determined by a UE.

Electronic label devices of the network, such as the electronic label device 501, periodically transmit beacons, such as described with reference to FIG. 3, and further with reference to FIGS. 6-9. The beacons may be used by electronic label system and non-electronic label system devices to determine a relative position from the electronic label devices or a position within an electronic label device system, such as for DL positioning estimation when the devices or controllers/radios transmit the beacons, and the beacons are received by the wireless device 503. Additionally, the wireless device 503 or eTags 593 may transmit beacons which are measured by other electronic label devices for use in UL positioning estimation.

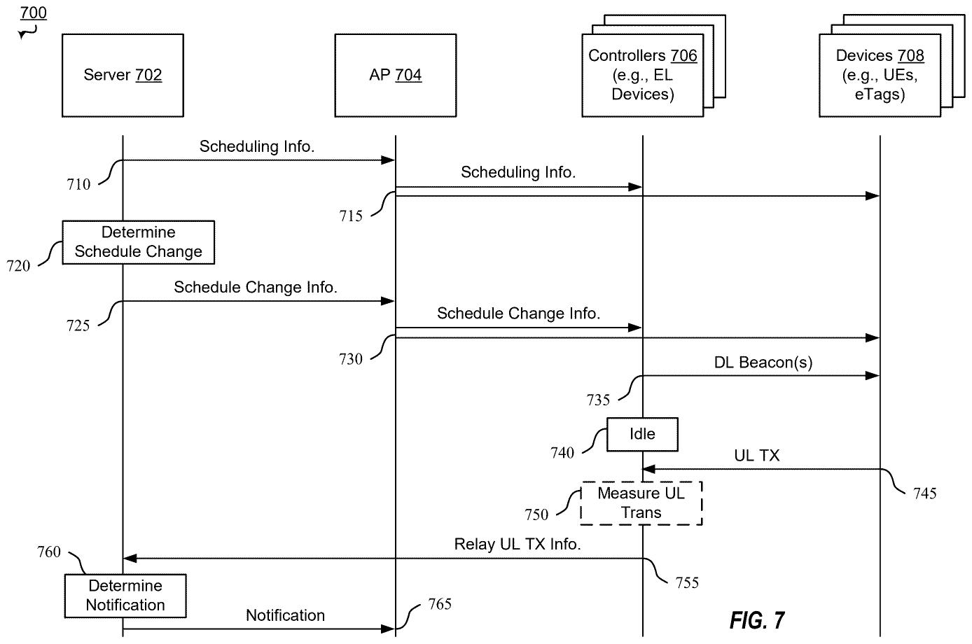

In some aspects, the beacons transmitted by electronic label devices and/or the wireless device 503 may be initiated by a beacon start transmission, not sure in FIG. 5. The beacon start transmission may be optionally sent by an electronic label device, such as an AP, and the beacon start transmission may trigger beacons to be transmitted and monitored for by other devices according to or based on the scheduling information 506, as further described with reference to FIGS. 6 and 7.

In electronic label device systems, the devices of the system and that interact with the system may have different gap transmission constraints, and/or the gap transmission constraints and/or resources of system devices (e.g., electronic labels) may change over time, due to degradation, upgrade/replacement, battery power usage, etc. In addition, demand on the system and available resources/bandwidth may change over time due to ordinary operations. In order to meet these needs, and to more efficiently meet these needs in a timely manner without wasting power, the system can make schedule changes to accommodate changing conditions and demands of the devices and network itself. The schedule change may also include one or more scheduling schemes that are generated in accordance with a gap transmission constraint or with multiple gap transmission constraints.

Moreover, in electronic label device systems the eTags 593 tags may move in and out of the electronic label device system and around through the electronic label device system. These eTags 593 may transmit in response to being charged from external devices. Based on their placement and distance from the external charging devices, referred to as energizers, the eTags 593 may have drastically different charging times. Accordingly, the eTags 593 may not transmit in every UL slot in a given UL window and may not even transmit in every UL window. Thus, a large portion of UL bandwidth may go unused. Additionally, even if the eTags 593 are transmitting in a window or slot, there may be unused transmit resources, such as UL transmit opportunities that may be available, such as combinations of time, spatial, frequency, and/or coding resources.

In the aspects described herein, the electronic label device 501 may optionally determine a schedule change for the electronic label devices and/or non-electronic label devices to better utilize the available bandwidth and to schedule individual devices and/or groups of devices with short transmission gaps to reduce power consumption. For example, the electronic label device 501 may determine whether adjust a transmission gap constraint of the schedule information or generate a new transmission gap constraint, and may determine a new schedule responsive to determining to adjust the transmission gap constraint of the schedule information or generate the new transmission gap constraint. To illustrate, the electronic label device 501 determines to adjust the transmission gap constraint based on a determination that a maximum idle power constraint of one or more devices has changed, that a current transmission gap constraint cannot accommodate currently scheduled or likely transmissions, that an amount of scheduled transmissions or devices has changed, etc., or any combination thereof. Additional examples for determining a schedule change are illustrated and described with reference to FIGS. 6-11C.

In some aspects, the electronic label device 501 may determine the schedule change further based on a region or area associated with the eTag transmission probability. For example, the electronic label device 501 may determine an area or region for each eTag or group of eTags and may assess the likelihood of transmission for that particular area and time. Additional details for eTag transmission determination are described further with reference to FIGS. 6-10.

After determination of the schedule change, the electronic label device 501 generates schedule change information 508 and transmits a schedule change transmission 554 including the schedule change information 508 to one or more electronic label devices, one or more non-electronic label system devices, or both. For example, the electronic label device 501 may transmit the schedule change transmission 556 to one or more electronic label devices to enable one or more of the electronic label devices to receive an UL transmission 556 and to transmit a DL beacon transmission 559 within a certain time frame to enable the electronic label device to perform an idle mode operation 558 (e.g., transition to or remain in an idle mode) and to refrain from performing a power save operation (e.g., enter a lower power state) between the reception of the UL transmission 556 and the transmission of the DL beacon transmission 559.

As another example, the electronic label device may transmit the schedule change transmission 554 to one or more non-electronic label devices, such as the wireless device 503 in the example of FIG. 5, to enable one or more of the non-electronic label system devices to transmit the UL transmission 556 and to receive the DL beacon transmission 559 within a certain time frame to enable the non-electronic label devices to perform an idle mode operation 558 (e.g., transition to or remain in an idle mode) and to refrain from performing a power save operation (e.g., enter a lower power state) between the transmission of the UL transmission 556 and the reception of the DL beacon transmission 559.

Although one schedule change is illustrated in the example of FIG. 5, the electronic label device 501 may generate multiple schedule changes for different devices and/or different regions to better utilize the UL bandwidth of the electronic label device system. The increased usage of UL bandwidth, and the transmissions therein, can also be used to further reduce the transmission gap time of the schedule and further reduce power consumption of the devices when remaining in the idle mode.

Additional examples of schedule generation and change operations, including descriptions and examples for generating the schedules and usage of the determined position information, are described further with reference to FIGS. 6-11C. For example, generation of notifications, transmission of notifications, and illustrative examples of notifications are described further with reference to FIGS. 6-11C.

Accordingly, the network (e.g., the electronic label device 501 and the wireless device 503) may be able to perform enhanced scheduling operations for downlink and uplink positioning coexistence, and optionally electronic label device system position-based notification operations. Accordingly, the electronic label device system network performance and network and user experience may be increased due to enhanced electronic label device system capabilities based on electronic label device-based positions and notifications and reduced power consumption.

Referring to FIG. 6, FIG. 6 is a timing diagram 600 illustrating an electronic label device system that supports UL and DL schedule modifications according to one or more aspects. The example of FIG. 6 corresponds to an example of enhanced downlink and uplink coexistence by UL and DL schedule modifications. The example FIG. 6 may enable improved determination of system-based positions (e.g., a position within or with reference to an electronic label device system or infrastructure thereof) for external devices based on signals and information received from one or more infrastructure devices by increasing UL utilization and reducing power consumption.

In the example of FIG. 6, the electronic label device system includes a server 602, an AP 604, controller(s) 606 (e.g., electronic label device(s)), and device(s) 608 (e.g., UEs). The controller(s) 606 may each include or correspond to an electronic label device with a wireless radio, or a wireless device/radio associated with a plurality of electronic label devices. Although one AP is illustrated, the electronic label device system may include multiple APs, each serving multiple controllers and devices.

Prior to 610, the electronic label device system may be configured with initial position information and/or configurations for network operation and positioning determination operations. For example, an operator may setup or preconfigure the system with initial positions for one or more devices and/or assets of the electronic label device systems. To illustrate, one or more of APs, controllers, electronic label devices, or assets (which may be tagged with an IoT tag) may be configured with an initial position. As another example, the electronic label device system may enter, such as upon initial setup, reconfiguration, or periodically (e.g., nightly weekly, monthly, quarterly, etc.), a measurement mode to determine initial or updated positions.

For example, the server 602 may transmit configuration information (e.g., the configuration transmission 550 or the settings information 546 of FIG. 5) to the AP 604 and the controllers 606. To illustrate, the server 602 may transmit the configuration information directly to each device, such as by broadcast transmission or direct transmission, or the server 602 may transmit the configuration information to AP 604, which then transmits or relays then configuration information to one or more electronic label devices, such as the controllers 606. In an illustrative, non-limiting example, the server 602 may transmit the configuration to AP 604 via a wired connection, and the AP 604 may unicast or broadcast the configuration information to the electronic label devices and non-electronic label devices.

As described above, the configuration information may include information configured to enable scheduling and timing coordination. For example, the configuration information may include UL and DL slot timing information for the different devices or types/groups of devices.

Additionally, or alternatively, initial position information may be transmitted in the configuration information. For example, the operator may input a position into the controllers 606, and the controllers 606 may relay that position to the server 602 via the AP 604. As another example, the operator may configure the server 602 with the position of the controllers 606, which is then relayed to the controllers 606 via the AP 604. As yet another example, each of the controllers 606 determines its position based on a beacon of the AP 604, and transmits its determined position to the server 602.

At 610, the server 602 may transmit scheduling information to the devices 608 for participation in the electronic label device system. For example, the server 602 may unicast or broadcast a transmission to one or more external devices, including the devices 608 (e.g., UE), which indicates or includes scheduling information, such as the scheduling information 506 of FIG. 5. The devices 608 may utilize the scheduling information to determine UL slots for transmission of uplink transmissions (e.g., beacons or system requests), DL slots for reception of DL transmission (e.g., beacons for measurement or beacon start transmissions/timing transmissions), or both.

At 615, the server 602 may transmit scheduling information to the AP 604 for relay to other electronic label devices. For example, the server 602 may unicast or broadcast a transmission to one or more APs, including the AP 604, which indicates or includes scheduling information, such as the scheduling information 506 of FIG. 5. The AP 604 may utilize the scheduling information to determine UL slots for receiving UL transmissions (e.g., beacons or system requests), DL slots for transmitting DL transmission (e.g., beacons for measurement or beacon start transmissions/timing transmissions), or both.

In some aspects, the scheduling information (e.g., original schedule or base schedule) may have been generated by the system (e.g., the server 602) in accordance with a maximum gap time between transmit and receive operations for the controllers, the devices, or both. For example, the scheduling information may include transmit slots for the controllers (e.g., DL slots) that are no more than X slot away from receive slots (e.g., UL slots) based on a maximum gap or idle time for the controllers. In some such aspects where the system may include multiple types of controllers or controllers operating in different modes or for different assets, the server may generate the schedule in accordance with multiple maximum gap times between transmit and receive operations for the different types of controllers. For example, a first group of controllers may have a 1-slot maximum gap time, and a second group of controllers may have a 2-slot maximum gap time. Similarly, the server may generate the schedule in accordance with one or more different maximum gap times between transmit and receive operations for the devices. To illustrate, the devices may be higher power and complexity devices and may be able to handle a longer idle time or may require a shorter idle time to conserve power. The server 602 may also create the schedule such that it satisfies a gap time/idle power length constraint of the devices. In some such aspects, the server 602 may create the schedule such that multiple gap time/idle power length constraints for different devices are supported where the different devices may have different maximum lengths. The server 602 may create a schedule that still results in a power savings when the different devices are in an idle mode during the gaps as opposed to powering down and back up.

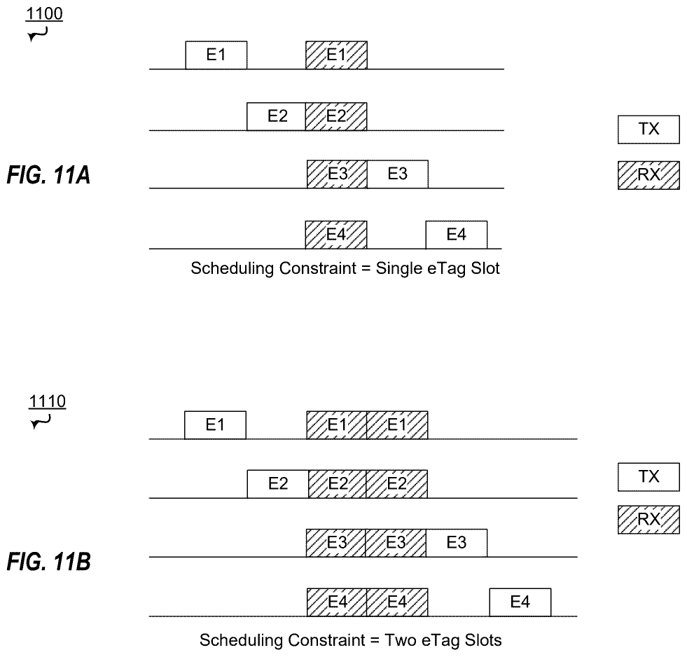

Even when an original schedule is created in accordance with satisfying an idle power length constraint, the server 602 may update the schedule from time to time to conserve power when updated measurements are not needed, to accommodate additional measurements, to accommodate device requests, to adjust to changing network or device conditions, etc. In the aspects described herein, the system can adjust the schedule periodically to better adapt to current conditions and network demand. One example of an original schedule with block scheduling for UL and DL coexistence operations for position-based service systems is illustrated in FIG. 10, and the schedule and block scheduling thereof may not satisfy transmission gap constraints. That is some DL slots are multiple (e.g., 10 slot away) from some UL slots. FIGS. 11A-11C illustrate schedules with reduced transmission gap lengths that enable reduced or eliminated power save operation may greatly reduce power consumption by system devices.

At 620, the AP 604 may transmit scheduling information to one or more controllers/devices, including the controllers 606. For example, the AP 604 may relay the scheduling information or transmit controller scheduling information based on the received scheduling information. The AP 604 may transmit the scheduling information by unicast or broadcast a transmission to the one or more controllers/devices. The one or more controllers/devices, including the controllers 606, may utilize the scheduling information to determine UL slots for receiving UL transmissions (e.g., beacons or system requests), DL slots for transmitting DL transmission (e.g., beacons for measurement or beacon start transmissions/timing transmissions), or both.

At 625, the AP 604 may initiate beacon transmissions by electronic label devices. For example, the AP 604 may transmit a beacon start transmission, such as the broadcast transmission at 302 of FIG. 3. To illustrate, the AP 604 may broadcast a transmission which is configured to cause controllers, including controllers 606, to transmit DL beacon transmissions, cause devices (e.g., devices 608) to measure the DL beacon transmissions, cause devices (e.g., devices 608) to transmit UL beacon transmissions, or a combination thereof. The beacon start transmission may include or correspond to a configuration transmission. In some aspects, such as when the beacon start transmission is a Bluetooth transmission, the beacon start transmission (or beacon start message) may correspond to a Bluetooth synchronization packet.

At 630, the controllers transmit one or more DL beacons. For example, one or more controllers, including the controllers 606, transmit a DL beacon during a first DL slot or window based on the scheduling information. The first DL slot or window may include or correspond to an originally scheduled DL slot or window. For example, the first DL slot or window may have originally been scheduled, assigned, or otherwise reserved for DL transmissions by the controllers. The controllers may determine the timing of the DL beacon based on both the scheduling information and the beacon start transmission (e.g., the transmission or reception time thereof).

At 635, the devices 608 transmit one or more UL beacons. For example, one or more devices, including the devices 608, transmit an UL beacon during a first UL slot or window based on the scheduling information. The first UL slot or window may include or correspond to an originally scheduled UL slot or window. For example, the first UL slot or window may have originally been scheduled, assigned, or otherwise reserved for UL transmissions by the devices. The devices may determine the timing of the UL beacon based on both the scheduling information, the beacon start transmission, and/or the DL beacons (e.g., the transmission or reception time thereof).

Although not shown in FIG. 6, the controllers and/or the devices may operate in an idle mode between the transmission and reception operations at 630 and 635, as described with reference to idle mode operations at 665 and 670, and may refrain from entering a power save mode or from performing a power save operation when the schedule information is created in accordance with a maximum idle length constraint and includes a schedule where multiple or all devices have gap between transmission and reception slots that satisfies this constraint.

At 640, the server 602 may determine a schedule change based on the device information. For example, the server 602 may determine an UL schedule change, a DL schedule change, or both based on the device information, such as based on schedule change information generated based on the device idle time constraints, power down and power up power, device power resources, device requests, and/or device mode. To illustrate, the server 602 may identify a subset of devices that should be scheduled and/or are likely to transmit and then may utilize one or more device related conditions, such as one or more thresholds, for the devices to set an amount of time (e.g., idle time) between transmit and receive slots for the scheduled/likely to transmit devices. For example, the server 602 may utilize a maximum idle time per device to create a schedule that has TX slots and RX slots for the devices where no idle time (e.g., gap between TX and RX slots) exceeds the maximum idle time, and where the maximum idle time results in a power savings for operating in an idle mode during the gap as opposed to powering down and powering up.

Determining the schedule may include evaluating whether to increase or decrease a base or originally scheduled amount of time (e.g., idle time) between transmit and receive slots for scheduled devices. In some aspects, the server 602 may use an AI/ML model to determine whether to implement a schedule change, and optionally, to determine the particular schedule change (e.g., amount of idle time or adjustment amount for the idle time).

In some aspects, the server 602 may determine whether to make an UL schedule change based on the determined uplink transmit possibilities, and then may determine to make a DL schedule change based on the determination to make the UL schedule change or based on a determination that the repurposed or rescheduled UL slots were actually used. In other aspects, the server 602 may determine whether to make UL and DL schedule changes based on the determined uplink transmit possibilities. For example, DL slots corresponding to uplink slots identified as available (e.g., low likelihood of eTag transmission or low number of eTag transmissions), may also be rescheduled or repurposed.

At 645, the server 602 may transmit UL schedule change information to one or more of the devices 608 for enhanced UL and DL coexistence operations. For example, the server 602 may unicast or broadcast a transmission to one or more APs, including the AP 604, which indicates or includes the schedule change information, and the AP 604 then relays the schedule change information to one or more the devices 608, such as by Wi-Fi or Bluetooth transmission. Alternatively, the APs transmit device or group specific UL schedule change information to specific devices or groups of devices based on the received UL schedule change information. To illustrate, only certain areas of the electronic label device system may be affected by the change and only the applicable APs and controllers may receive and transmit the UL schedule change information for the affected devices. As another example, the server 602 may transmit the schedule change information to the devices 608 via another wireless network, such as a cellular network, or via the Internet.

As described herein, the schedule change information transmitted to the devices 608 may include or correspond to UL only schedule information or combined UL and DL schedule change information. In some aspects, the devices 608 may infer DL changes, such as to perform a power save operation for particular DL slots, based on explicitly indicated uplink changes in UL only schedule change information. As described further herein, the schedule change information enables one or more of the devices 608 to engage in UL-based position determination operations, and such may enable one or more electronic label devices to refrain from engaging in DL-based position determination operations to save power.

Although the UL schedule change information and DL schedule change information are illustrated in different transmissions in the example of FIG. 6, such may be included in the same transmission in other examples. For example, in some implementations the beacon start transmissions sent by the APs, such as AP 604, may include or indicate the UL schedule change information, the DL schedule change information, or both.

At 650 and 655, the server 602 may transmit DL schedule change information to the electronic label devices for enhanced UL and DL coexistence operations. For example, the server 602 may unicast or broadcast a transmission to one or more APs, including the AP 604, at 650 and which indicates or includes the DL schedule change information, and the AP 604 then relays the DL schedule change information to the controllers, including controllers 606 at 655, such as by Wi-Fi or Bluetooth transmission. Alternatively, the APs transmit device or group specific DL schedule change information to specific controllers or groups of controllers based on the received DL schedule change information. To illustrate, only certain areas of the electronic label device system may be affected by the change and only the applicable APs and controllers may receive and transmit the schedule change information from the server and APs respectively. As described herein, the schedule change information transmitted to the controllers 606 may include or correspond to DL only schedule information or combined UL and DL schedule change information. In some aspects, the controllers 606 may infer UL changes, such as to monitor one or more UL slots, based on explicitly indicated downlink changes in DL only schedule change information.

Additionally, the server 602 may transmit DL schedule change information to the devices 608 for enhanced power save operations in some implementations. For example, the server 602 may transmit the DL schedule change information with the UL schedule change information or via one of the distribution methods described with reference to the UL schedule change information above. As another example, the devices 608 may receive the DL schedule change information via beacon type transmissions from the APs or controllers, similar to how controllers receive the DL schedule change information.

After relaying the schedule change information at 655, the AP 604 may initiate beacon transmissions by electronic label devices during a second cycle (not shown in FIG. 6 for clarity). For example, the AP 604 may transmit a second beacon start transmission, such as the broadcast transmission at 302 of FIG. 3. To illustrate, the AP 604 may broadcast a transmission which is configured to cause controllers, including controllers 606, to transmit DL beacon transmissions, cause devices (e.g., devices 608) to measure the DL beacon transmissions, cause devices (e.g., devices 608) to transmit UL beacon transmissions, or a combination thereof. The beacon start transmission may include or correspond to a configuration transmission. In some aspects, such as when the beacon start transmission is a Bluetooth transmission, the beacon start transmission (or beacon start message) may correspond to a Bluetooth synchronization packet.

At 660, one or more of the controllers transmit one or more DL beacons during a second cycle. For example, one or more controllers, including the controllers 606, transmit a DL beacon during a first DL slot or window based on the schedule change information and responsive to the second beacon start transmission by the AP 604. The first DL slot or window may include or correspond to an originally scheduled DL slot or window or a changed DL slot or window. For example, the first DL slot or window may have originally been scheduled, assigned, or otherwise reserved for DL transmissions by the controllers. The controllers may determine the timing of the DL beacon based on the scheduling information, the schedule change information, and a second beacon start transmission (e.g., the transmission or reception time thereof) not shown in FIG. 6 for clarity.

At 665, one or more of the controllers 606 performs an idle operation to remain in an idle mode between the transmission of DL beacons at 660 and the monitoring for and reception of UL beacons at 675. For example, the first controller of the controllers 606 remains in an operational state for wireless communications and does not reduce or cut power to a transceiver and/or related components based on the schedule change information and/or based on the amount of time or slots between the transmission and reception slots this cycle. The first controller of the controllers 606 refrains from performing a power save operation between the transmission of DL beacons at 660 and the monitoring for and reception of UL beacons at 675. Other controllers that are scheduled for transmit and receive operations this cycle by the schedule change operation may also perform an idle mode operation and transition to or remain in an idle mode between the transmission of DL beacons at 660 and the monitoring for and reception of UL beacons at 675. The controllers remain in the idle state between the DL slots and/or the UL slots indicated in the schedule change information. The controllers 606 may receive the schedule change information (e.g., DL schedule change information) from the server 602 directly or via another electronic label device system component (e.g., relayed by one or more electronic label device system components). To illustrate, the DL schedule change information may be relayed by the AP 604 in unicast or broadcast transmission or included in beacon transmissions (e.g., beacon starts and/or beacon transmissions).

In some aspects, one or more of the devices 608 may also optionally perform an idle mode operation at 670, similar to the idle mode operation by one or more of the controllers 606 at 665. For example, the first device of the devices 608 remains in an operational state for wireless communications and does not reduce or cut power to a transceiver and/or related components based on the schedule change information and/or based on the amount of time or slots between the transmission and reception slots this cycle. The first device of the devices 608 refrains from performing a power save operation between the monitoring for and reception of DL beacons at 660 and the transmission of UL beacons at 675. Other devices that are scheduled for transmit and receive operations this cycle by the schedule change operation may also perform an idle mode operation and transition to or remain in an idle mode between the DL beacons at 660 and the UL beacons at 675. The devices 608 may receive the UL schedule change information from the server 602 directly, as illustrated in the example of FIG. 6, or via another electronic label device system component (e.g., relayed by one or more electronic label device system components). To illustrate, the UL schedule change information may be relayed by the AP 604 in unicast or broadcast transmission or included in beacon transmissions (e.g., beacon starts and/or beacon transmissions), as described with reference to FIG. 7.

After the schedule change information is transmitted, other devices associated with the system and not scheduled by the schedule change information for any communications this cycle may perform a power save operation and may not engage in transmission or reception operations this cycle. Additionally, or alternatively, other devices associated with the system and not scheduled by the schedule change information for both transmission and reception operations this cycle may perform a power save operation after the single type operations scheduled (e.g., transmit only or receive only).

At 675, one or more of the devices 608 transmit one or more UL beacons during the second cycle. For example, at least one device of the devices 608 transmits an UL beacon during a first UL slot or window of the second cycle, or a particular uplink transmit opportunity thereof, based on the UL schedule change information. The first UL slot or window may include or correspond to a rescheduled or a repurposed UL slot or window or a rescheduled or a repurposed uplink transmit opportunity thereof. For example, the first UL slot or window may have originally been scheduled, assigned, or otherwise reserved for UL transmissions by other electronic label devices, such as eTags, (e.g., eTag UL beacons) or other external devices. The devices 608 may determine the timing of the UL beacon based on both the scheduling information and the UL schedule change information. Additionally, or alternatively, the devices 608 may further determine the timing of the UL beacon based on the DL schedule change information.

At 680, the controllers of the electronic label device system receive one or more UL beacons and measures the one or more UL beacons. For example, a first controller of the controllers 606 measures a first RSSI from a first beacon from a first device of the devices 608 and a second controller thereof measures a second RSSI of the first beacon from the first device. In some implementations, the first device and/or other devices of the devices 608 may send additional beacons, such as in subsequent UL windows, and the controllers may measure these subsequent beacon(s). The controllers, including controllers 606, may generate measurement information based on performing one or more measurement operations on the received UL beacon(s) from the device(s) 608, and other devices not shown. Additionally, or alternatively, the measurement information may include RSRP, AoA, TOA, or any combination thereof. As described above, the beacons include an address of the device which sent the beacon. This enables the electronic label device system to identify outside devices, such as devices 608.

At 685, the controllers 606 transmit measurement information for the devices 608 to the electronic label device system. For example, two or more controllers, including controllers 606, each transmit measurement information to the server 702 via the AP 704. The measurement information, such as measurement information 542 of FIG. 5, from multiple controllers and/or from multiple beacons can be used together to determine (e.g., triangulate) a position of a particular device of the devices 608, such as a position indicated by position information 545 of FIG. 5.

In some implementations, one of the devices 608 transmits a request, such as request information, indicating a position-based request to the electronic label device system. For example, a first device of the devices 608 may transmit a request to find a specific object or product (e.g., electronic label device associated with the object or product). The request may be sent with or independent of the positioning information. The electronic label device system may then use the positioning information to provide services to the device (e.g., a user thereof), such as guidance, and/or may use the positioning information to improve electronic label device system operations.

At 690, the server 602 determines a position for the devices 608 based on the received beacon measurement information from the controllers 606. For example, the server 602 determines a position, positioning information, of the first device of the devices 608 based on first measurement information (e.g., a first RSSI) from a first controller of the controllers 606 and the second measurement information (e.g., a second RSSI) from another controller of the controllers 606, where the first and second measurement information correspond to a measurement of the first beacon from the first device of the devices 608. In some implementations, the server 602 determines the position of the first device based on the additional (e.g., third) measurement information from one or more other beacons and based on historical measurement information, historical position information, or inertial information. For example, the server 602 may determine the position for the first device by adjusting an initial measured position based on prior positions, and/or prior beacon measurements. After determining a position of one or more of the devices, and receiving a request for a position-based notification, the server 602 may engage in position-based notification operations, described further with reference to FIG. 7.

Referring to FIG. 7, FIG. 7 is a timing diagram 700 illustrating an electronic label device system that supports enhanced electronic label device system scheduling operations for position determination coexistence according to one or more aspects. The example of FIG. 7 corresponds to an example of position determination for a device interacting with the electronic label device system where the measurements are determined based on signals or beacons from radios/controllers by the device, and then relayed to the electronic label device system for position determination.

In the example of FIG. 7, the electronic label device system includes a server 702, an AP 704, controller(s) 706 (e.g., electronic label device(s)), and device(s) 708 (e.g., UEs). The controller(s) 706 may each include or correspond to an electronic label device with a wireless radio, or a wireless device/radio associated with a plurality of electronic label devices. Although one AP is illustrated, the electronic label device system may include multiple APs, each serving multiple controllers and devices.

Prior to 710, the electronic label device system may be configured with initial position information and/or configurations for network operation and positioning determining operations. For example, an operator may setup or preconfigure the system with initial positions for one or more devices and/or assets of the electronic label device systems. To illustrate, one or more of APs, controllers, electronic label devices, or assets (which may be tagged with an IoT tag) may be configured with an initial position. As another example, the electronic label device system may enter, such as upon initial setup, reconfiguration, or periodically (e.g., nightly weekly, monthly, quarterly, etc.), a measurement mode to determine initial or updated positions.

For example, the server 702 may transmit configuration information (e.g., the configuration transmission 550 or the settings information 546 of FIG. 5) to the AP 704 and the controllers 706. To illustrate, the server 702 may transmit the configuration information directly to each device, such as by broadcast transmission or direct transmission, or the server 702 may transmit the configuration information to AP 704, which then transmits or relays then configuration information to one or more electronic label devices, such as the controllers 706. In an illustrative, non-limiting example, the server 702 may transmit the configuration to AP 704 via a wired connection, and the AP 704 may unicast or broadcast the configuration information to the electronic label devices and non-electronic label devices.

As described above, the configuration information may include information configured to enable scheduling and timing coordination. For example, the configuration information may include UL and DL slot timing information for the different devices or types/groups of devices.

Additionally, or alternatively, initial position information may be transmitted in the configuration information. For example, the operator may input a position into the controllers 706, and the controllers 706 may relay that position to the server 702 via the AP 704. As another example, the operator may configure the server 702 with the position of the controllers 706, which is then relayed to the controllers 706 via the AP 704. As yet another example, each of the controllers 706 determines its position based on a beacon of the AP 704, and transmits its determined position to the server 702.

At 710, the server 702 may transmit scheduling information to the AP 704 for relay to other electronic label devices and to non-electronic label devices. For example, the server 702 may unicast or broadcast a transmission to one or more APs, including the AP 704, which indicates or includes scheduling information. The AP 704 may utilize the scheduling information to determine UL slots for receiving UL transmissions (e.g., beacons or system requests), DL slots for transmitting DL transmission (e.g., beacons for measurement or beacon start transmissions/timing transmissions), or both.

At 715, the AP 704 may transmit scheduling information to one or more controllers/devices, including the controllers 706, to one or more devices, including devices 708, or a combination thereof. For example, the AP 704 may relay the scheduling information or transmit controller scheduling information based on the received scheduling information to the controllers. Additionally, or alternatively, example, the AP 704 may relay the scheduling information or transmit device scheduling information based on the received scheduling information to the devices. The scheduling information provided to the controllers and the non-electronic label devices may be transmitted in the same transmission or in different transmissions, such as BLE and Wi-Fi transmissions. In the alternative to the above where the AP 704 provides the scheduling information to the non-electronic label devices directly, in other implementation the AP provide the scheduling information to the non-electronic label devices via the controllers 706.

The AP 704 may transmit the scheduling information by unicast or broadcast a transmission to one or more to one or more controllers/devices. The one or more controllers/devices, including the controllers 706 and devices 708, may utilize the scheduling information to determine UL slots for UL transmissions (e.g., beacons or system requests), DL slots for DL transmission (e.g., beacons for measurement or beacon start transmissions/timing transmissions), or both.

As described with reference to FIG. 6, the scheduling information transmitted by the server 702 may satisfy and/or be generated based on a maximum idle length constraint. For example, an original maximum idle length constraint of the controllers 706 may be used as a maximum transmission gap scheduling time between UL and DL slots for the controllers and devices of the system. Illustrative, non-limiting examples of schedules that satisfy a maximum idle length constraint or maximum time gap constraint are illustrated and described further with reference to FIGS. 11A-11C.

At 720, the server 702 may determine a schedule change based on one or more maximum idle length constraints. For example, the server 702 may determine an UL schedule change, a DL schedule change, or both based on an adjustment to a maximum idle length constraint and/or based on changes in network and/or device resources. To illustrate, the server 702 may utilize one or more conditions, such as one or more thresholds, to evaluate the maximum idle length constraint. For example, the server 702 may utilize device information regarding power consumption, maximum idle length constraints, scheduling request, priority, resource, operating mode, etc. to determine whether to adjust a maximum idle length constraint of the system/current schedule or whether the current maximum idle length constraint can generate a schedule to accommodate device position-based requested and/or updates of system positions. Alternatively, the server 702 may use an AI/ML model to determine whether to implement a schedule change, and optionally, to determine the particular schedule change (e.g., which slot or slots to reschedule or repurpose).

Similar to the schedule information, the schedule change information, and timing scheme or schemes thereof, may also satisfy and/or be generated based on a maximum idle length constraint. For example, an original maximum idle length constraint of the electronic label devices (e.g., device 802) of the system may be adjusted, and the adjusted maximum idle length constraint may be used as a second maximum transmission gap scheduling time between UL and DL slots for any of the devices of the system during a second cycle, and optionally during subsequent cycles.

As described with reference to FIG. 6, in some aspects the schedule change information may be further determined based on transmit possibilities. For example, the server 702 may utilize and AI/ML model to predict potential UL transmissions by one or more devices of the devices 708 and may then adjust the original schedule or generate a new schedule based on the predicted UL transmissions or potential transmissions and based on the idle gap length constraint(s).

Although the UL schedule change information and DL schedule change information are illustrated in different transmissions in the example of FIG. 7, such may be included in the same transmission in other examples. For example, in some implementations the beacon start transmissions sent by the APs, such as AP 704, may include or indicate the UL schedule change information, the DL schedule change information, or both.

At 725, the server 702 may transmit schedule change information for enhanced UL and DL coexistence operations. The server 702 may provide schedule change information to the electronic label devices and non-electronic label devices similar to transmission schemes described above for the server 702 providing the scheduling information to the electronic label devices and non-electronic label devices. For example, the server 702 may unicast or broadcast a transmission to one or more APs, including the AP 704, which indicates or includes the schedule change information, and the AP 704 then relays the schedule change information to the controllers 706 and devices 708, such as by Wi-Fi or Bluetooth transmission. Alternatively, the APs transmit UL device controller schedule change information to specific devices or groups of devices based on the received UL schedule change information. To illustrate, only certain areas of the electronic label device system may be affected by the change and only the applicable APs and controllers may receive and transmit the UL schedule change information for the affected devices. As another example, the server 702 may transmit the schedule change information, or a portion thereof, to the devices 708 via another wireless network, such as a cellular network, or via the Internet, similar to as described with reference to FIG. 6.

At 730, the AP 704 may transmit the received schedule change information to the electronic label devices and non-electronic label devices for enhanced UL and DL coexistence operations. For example, the AP 704 relays at least the DL schedule change information to the controllers, including controllers 706 and at least the UL schedule change information to the devices, including devices 708, such as by Wi-Fi or Bluetooth transmission. Alternatively, the APs may transmit device or group specific schedule change information to specific controllers or groups of controllers based on the received schedule change information. To illustrate, only certain areas of the electronic label device system may be affected by the change and only the applicable APs and controllers may receive and transmit the schedule change information from the server and APs respectively. Similarly, the APs may transmit device or group specific schedule change information to specific devices of devices 608 based on the received schedule change information.

Additionally, the server 702 and/or AP 704 may transmit DL schedule change information to the one or more of the devices 708 for enhanced power save operations in some implementations. For example, the AP 704 server 702 may transmit the DL schedule change information with the UL schedule change information or via one of the distribution methods described with reference to the UL schedule change information above. As another example, one or more of the devices 708 may receive the DL schedule change information via beacon type transmissions from the APs or controllers, similar to how controllers receive the DL schedule change information. Similarly, the server 702 and/or AP 704 may transmit UL schedule change information to one or more of the controllers 706 for measuring uplink beacons in some implementations. When the UL schedule change information indicates an uplink grant for a notification request, the UL transmission (i.e., the notification request) may not be measured to the controllers 706 and/or the controllers 706 may engage in a power save operation to conserve battery as they may not need to measure any uplink beacons.

After relaying the schedule change information, the AP 704 may initiate beacon transmissions by electronic label devices. For example, the AP 704 may transmit a beacon start transmission (not shown in FIG. 7) to initiate beacon transmissions or provide timing information for the beacon transmissions in a second cycle. To illustrate, the AP 704 may broadcast a transmission, such as the broadcast transmission at 302 of FIG. 3, which is configured to cause controllers, including controllers 706, to transmit DL beacon transmissions, cause devices (e.g., devices 708) to measure the DL beacon transmissions, cause devices (e.g., devices 708) to transmit UL beacon transmissions, or a combination thereof. The beacon start transmission may include or correspond to a configuration transmission. In some aspects, such as when the beacon start transmission is a Bluetooth transmission, the beacon start transmission (or beacon start message) may correspond to a Bluetooth synchronization packet.

At 735, one or more of the controllers transmit one or more DL beacons during the second cycle. For example, one or more controllers, including the controllers 706, transmit a DL beacon during a first DL slot or window based on the schedule change information and responsive to the second beacon start transmission by the AP 704. The first DL slot or window may include or correspond to an originally scheduled DL slot or window or a changed DL slot or window (e.g., an originally scheduled UL window of the first cycle). For example, the first DL slot or window may have originally been scheduled, assigned, or otherwise reserved for DL transmissions by the controllers. The controllers may determine the timing of the DL beacon based on the scheduling information, the schedule change information, and a second beacon start transmission (e.g., the transmission or reception time thereof) not shown in FIG. 7 for clarity.

At 740, one or more of the controllers 706 performs an idle operation to remain in an idle mode between the transmission of DL beacons at 735 and the monitoring for and reception of UL transmissions at 745. For example, the first controller of the controllers 706 remains in an operational state for wireless communications and does not reduce or cut power to a transceiver and/or related components based on the schedule change information and/or based on the amount of time or slots between the transmission and reception slots this cycle. The first controller of the controllers 706 refrains from performing a power save operation between the transmission of DL beacons at 735 and the monitoring for and reception of UL transmissions at 745. Other controllers that are scheduled for transmit and receive operations this cycle by the schedule change operation may also perform an idle mode operation and transition to or remain in an idle mode between the transmission of DL beacons at 760 and the monitoring for and reception of UL transmissions at 745. The controllers remain in the idle state between the DL slots and/or the UL slots indicated in the schedule change information. The controllers 706 may receive the schedule change information (e.g., DL schedule change information) from the server 702 directly or via another electronic label device system component (e.g., relayed by one or more electronic label device system components). To illustrate, the DL schedule change information may be relayed by the AP 704 in unicast or broadcast transmission or included in beacon transmissions (e.g., beacon starts and/or beacon transmissions).

In some aspects, one or more of the devices 708 may also optionally perform an idle mode operation after 735 (e.g., at 740), similar to the idle mode operation by one or more of the controllers 706 at 740. For example, the first device of the devices 708 remains in an operational state for wireless communications and does not reduce or cut power to a transceiver and/or related components based on the schedule change information and/or based on the amount of time or slots between the transmission and reception slots this cycle. The first device of the devices 708 refrains from performing a power save operation between the monitoring for and reception of DL beacons at 735 and the transmission of UL transmission at 745. Other devices that are scheduled for transmit and receive operations this cycle by the schedule change operation may also perform an idle mode operation and transition to or remain in an idle mode between the DL beacons at 735 and the UL transmissions at 745. The devices 708 may receive the UL schedule change information from the server 702 directly, as illustrated in the example of FIG. 6, or via another electronic label device system component (e.g., relayed by one or more electronic label device system components). To illustrate, the UL schedule change information may be relayed by the AP 704 in unicast or broadcast transmission or included in beacon transmissions (e.g., beacon starts and/or beacon transmissions), as described with reference to FIG. 7.

After the schedule change information is transmitted, other devices associated with the system and not scheduled by the schedule change information for any communications this cycle may perform a power save operation and may not engage in transmission or reception operations this cycle. Additionally, or alternatively, other devices associated with the system and not scheduled by the schedule change information for both transmission and reception operations this cycle may perform a power save operation after the single type operations scheduled (e.g., transmit only or receive only).

At 745, at least one of the devices 708 transmits an uplink transmission. For example, the first device of the devices 708 transmits a position-based system request (e.g., position-based notification request) during a first UL slot or window based on the UL schedule change information. As another example, the first device transmits an UL beacon during a first UL slot or window based on the UL schedule change information, as described with reference to 675 of FIG. 6. The first UL slot or window may include or correspond to a rescheduled or a repurposed UL slot or window. For example, the first UL slot or window may have originally been scheduled, assigned, or otherwise reserved for UL transmissions by other electronic label devices, such as eTags, (e.g., eTag UL beacons) or other external devices. The devices 708 may determine the timing of the UL beacon based on both the scheduling information and the UL schedule change information. Additionally, or alternatively, the devices 708 may further determine the timing of the UL beacon based on the DL schedule change information.

At 750, the controllers of the electronic label device system receive the UL transmission and measure the UL transmission. For example, a first controller of the controllers 706 measures a first RSSI from a first UL transmission from a particular device of the devices 708 and a second controller thereof measures a second RSSI of the first UL transmission from the particular device of the devices 708. In some implementations, the particular device or other devices of the devices 708 may send additional UL transmissions, such as in subsequent UL windows, and the controllers may measure these subsequent UL transmission(s). The controllers, including controllers 706, may generate measurement information based on performing one or more measurement operations on the received UL transmission(s) from the devices 708, and other devices not shown. Additionally, or alternatively, the measurement information may include RSRP, AoA, TOA, or any combination thereof. As described above, the UL transmissions, such as beacons or requests, include an address of the device which sent the UL transmission. This enables the electronic label device system to identify outside devices, such as devices 708.

At 755, one or more of the controllers of the electronic label device system transmit UL transmission information to the server. For example, multiple controllers, including the controllers 706, may transmit measurement information for one or more of the devices 708 and based on measuring the UL transmission. Additionally, or alternatively, a controller may transmit or relay a request from one or more of the devices 708 to the server 702, such as to relay request information to the server 702 or to generate and transmit device request information to the server 702 based on the UL transmission (e.g., request information thereof).

In the aspects where the controllers 706 transmit measurement information for the devices 708 to the electronic label device system at 755, two or more controllers of the controllers 706 each transmits measurement information to the server 702 via the AP 704. The measurement information from multiple controllers and/or from multiple beacons can be used together to determine (e.g., triangulate) a position of one or more of the devices 708. In some such aspects, the measurement information may be generated based on measuring the uplink transmission(s) from one or more of the devices 708, such as measuring an UL beacon or a notification request.

In some implementations, one or more of the devices 708 transmits a request, such as request information, indicating a position-based request to the electronic label device system. For example, the first device of the devices 708 may transmit a request to find a specific object or product (e.g., an object or product associated with the electronic label device system). The request may be sent with or independent of the positioning information. The electronic label device system may then use the positioning information to provide services to the device (e.g., a user thereof), such as guidance, and/or may use the positioning information to improve system operations.

In some aspects, the server 702 determines a position for one or more of the devices 708 based on the received beacon measurement information from the controllers at 755. For example, the server 702 determines a position, positioning information, of the first device of the devices 708 based on first measurement information (e.g., a first RSSI) from a first controller and the second measurement information (e.g., a second RSSI) from another controller, where the first and second measurement information correspond to a measurement of the first beacon from the first device of the devices 708. In some implementations, the server 702 determines the position of the first device of the devices 708 based on the additional (e.g., third) measurement information from one or more other beacons and based on historical measurement information, historical position information, or inertial information. For example, the server 702 may determine the position for the first device of the devices 708 by adjusting an initial measured position based on prior positions, and/or prior beacon measurements.

At 760, the electronic label device system determines a notification based on the positioning information. For example, the server 702 determines a request for directions from a particular device of the devices 708 for a particular object, and the server determines directions from the position of the particular device of the devices 708 indicated by the positioning information to a position of the object or product stored in the electronic label device system.

At 765, the electronic label device system transmits the notification based on the positioning information, and optionally the request information. For example, the server 702 transmits a notification indicating the directions from the position of a particular device of the devices 708 to the position of the object or product stored in the electronic label device system to the AP 704, as illustrated in FIG. 7. In some aspects, the notification, or the notification information thereof, is transmitted or relayed to one or more controllers 706, one or more of the devices 708, or both. To illustrate, directions can be provided to one or more of the devices 708 and visual and/or audio indications can be provided to one or more of the controllers 706 for outputting such indications to guide a particular device (e.g., user thereof) to the object or product, or location. Additionally, or alternatively, the server 702 transmits a notification indicating the directions from the position of a particular device of the devices 708 to the position of the object or product to one or more of the devices 708 outside of the electronic label device system, such as independent of the AP 704 and via a cellular network connection.

Although energizer and eTags, such as energizer 804 and eTag 806, are not illustrated in the diagrams of FIG. 6 or 7, the electronic label device system may include one or more energizer and one or more eTags as illustrated in FIG. 8 and such energizers and eTags may engage in charging and UL beacon operations to enable determination of positions of the eTags (e.g., products associated therewith) and to enable directions/notifications to be provided to devices (e.g., electronic label devices and non-electronic label devices) to help the devices navigate to and locate the eTags (and associated product(s)).

Referring to FIG. 8, FIG. 8 is a timing diagram 800 illustrating an example of an electronic label device system that supports enhanced scheduling operations for DL and UL positioning coexistence according to one or more aspects. In the example of FIG. 8, the electronic label device system includes an electronic label device 802, one or more energizers, including energizer 804, one or more eTags 806. and or more devices 808. The electronic label device 802 may include or correspond to any electronic label device or devices of the electronic label device system, such as the server, AP, or controller/radio, as in any of FIGS. 1A-7. The energizer 804 may include or correspond to a device which transmits wireless signals for power harvesting by eTags 806, and the eTags 806 may include or correspond to the eTags 593 of FIG. 5. In some aspects, the energizer could be an AP, controller, or UE device. For example, the eTags 806 may harvest energy from ambient RF signals as opposed to dedicated energizer signals. The devices 808 may include or correspond to one or more of an electronic label device system UE or device (e.g., employee UE, robot UE, barcode scanner, etc.) or to a non-electronic label device system UE or device (e.g., a shopper or customer UE).

Prior to operation, and optionally periodically during operation, the electronic label device system may determine and propagate initial configuration and/or position information to electronic label devices and non-electronic label devices and optionally receive initial configuration and/or position information from the electronic label devices and non-electronic label devices, as described with reference to FIGS. 5-7. At 810, the electronic label device 802 transmits scheduling information to energizers of the electronic label device system, including the energizer 804. For example, the electronic label device 802 transmits a configuration transmission or scheduling information transmissions which includes or indicates a timing scheme or transmission schedule for the network, such as one or more electronic label devices thereof, and optionally for non-electronic label devices. Alternatively, the electronic label device 802 may transmit a trigger transmission, such as a beacon start transmission or an energizing start transmission, after the energizers have received timing information, to start or coordinate the transmission of energizing signals. The transmission may come from an AP or a controller of the electronic label device system. In some such implementations, the electronic label device 802 (e.g., the same type of electronic label device) transmits scheduling information in a first transmission and then later transmits a trigger transmission to one or more of the energizers, such as the energizer 804. In other such implementations, the electronic label device 802 transmits the scheduling information or the trigger transmission and another electronic label device (e.g., another type of electronic label device) transmits the other of the scheduling information or the trigger transmission.

As described with reference to FIGS. 5-7, the scheduling information, and timing scheme or schemes thereof, may satisfy and/or be generated based on a maximum idle length constraint. For example, an original maximum idle length constraint of the electronic label devices (e.g., device 802) of the system may be used as a maximum transmission gap scheduling time between UL and DL slots for any of the devices of the system.

At 815, one or more of the energizers transmit RF energy towards one or more eTags of the system. For example, the energizer 804 may broadcast a signal in one or more directions with signal characteristics that enable external devices to harvest the RF energy and convert it to power. For example, the energizer 804 may transmit a signal with a particular frequency (e.g., in a 500-3500 MHz range) and/or a particular waveform type (e.g., a Sinusoidal waveform), as one illustrative, non-limiting example.

At 820, the eTags 806 charge based on received energizer signals, including the energizer signal from the energizer 804 at 815. For example, the eTags 806 receive the energizer signal from the energizer 804 and processes the signal to harvest energy from the signal. To illustrate, each eTag 806 may include a rectifier, and optionally an impedance matching circuit, to convert the received analog RF energy into DC power. The eTags 806 may harvest energy from multiple energizer signals to charge in some implementations. In some such implementations, the multiple energizer signals may be transmitted by a single energizer device, e.g., serially over multiple energizer windows, or by multiple energizer device over a single energizer window or multiple energizer windows. The time to charge for a particular eTag is based on the signals received and the particular device. The charging time is highly correlated with the distance from the energizer device or devices, such as the energizer 804, and is inversely related to the signal strength and/or distance. For example, the charging time is lowest when the eTag is nearer/closer to one or more energizer device or devices, the charging time grows logarithmically and or exponentially as the eTag is further from the energizer device or devices.

At 825, one or more of the eTags 806 transmit UL beacons responsive to being charged. For example, a first eTag of the eTags 806 transmits an UL beacon after charging at 820 and during an UL window determined by the scheduling information and optionally a trigger transmission. To illustrate, each eTag 806 may be determine an UL window based on timing/scheduling information and then may determine to transmit during a particular time during the UL window based on being charged (e.g., power/voltage greater than a power/voltage threshold) and based on a random timing backoff. The random timing backoff may be determined based on the Q-value provided by the network or pre-stored at the eTag and one example for determining the timing is illustrated and described with reference to FIG. 10. The UL beacons by the eTags 806 may be used by the electronic label device system and devices interacting with the electronic label device system to determine position measurements and for notifications as described with reference to FIGS. 5-7.

At 830, the electronic label device 802 transmits schedule change information. For example, the electronic label device 802 transmits UL schedule change information, DL schedule change information, or both (e.g., combined schedule change information or both UL and DL schedule change information) that was determined based on UL transmission inference information/probability information, as described with reference to FIGS. 5-7. The schedule change information may identify one or more devices, one or more groups or subsets of devices, one or more UL slot changes, one or more DL slot changes, or a combination thereof, and may enable non-electronic label devices to utilize UL slots where eTags would normally transmit or attempt to transmit and/or enable electronic label devices and non-electronic label devices to refrain from transmitting or measuring downlink symbols to enable power savings or entering power saving modes, as described with reference to FIGS. 5-7.

As described with reference to FIGS. 5-7, the schedule change information, and timing scheme or schemes thereof, may satisfy and/or be generated based on a maximum idle length constraint. For example, an original maximum idle length constraint of the electronic label devices (e.g., device 802) of the system may be adjusted, and the adjusted maximum idle length constraint may be used as a second maximum transmission gap scheduling time between UL and DL slots for any of the devices of the system during a second cycle, and optionally during subsequent cycles. Illustrative, non-limiting examples of schedules that satisfy a maximum idle length constraint or maximum time gap constraint are illustrated and described further with reference to FIGS. 11A-11C.

After relaying the schedule change information at 830, the device 802 or an AP may initiate beacon transmissions by electronic label devices during a second cycle (not shown in FIG. 8 for clarity). For example, the device 802 or an AP may transmit a second beacon start transmission (not shown in FIG. 8) to provide timing information for a second cycle. To illustrate, the AP 804 may broadcast a transmission, such as the broadcast transmission at 302 of FIG. 3, which is configured to cause controllers, such as device 802, to transmit DL beacon transmissions, cause devices (e.g., devices 808) to measure the DL beacon transmissions, cause devices (e.g., devices 808) to transmit UL beacon transmissions, or a combination thereof. The beacon start transmission may include or correspond to a configuration transmission. In some aspects, such as when the beacon start transmission is a Bluetooth transmission, the beacon start transmission (or beacon start message) may correspond to a Bluetooth synchronization packet. The second beacon start transmission may also cause energizers, such as energizer 804, to transmit energizer signals and/or refrain from transmitting energizer signals during the second cycle.

At 835, one or more of the energizers transmit second RF energy towards one or more eTags of the system. For example, the energizer 804 may broadcast a signal in one or more directions with characteristics that enable external devices to harvest the RF energy and convert it to power, similar to as described at 815. In some aspects, the energizer 804 transmits a second energizer signal during the second cycle based on the schedule change information. For example, the energizer 804 may adjust a transmission timing of when the second energizer signal is sent (as compared to the first energizer signal sent during the first cycle), a transmission power aspect of the energizer signal, or a timing indication of the energizer signal. For example, the energizer 804 may adjust a WUS-D portion of the second energizer signal to indicate a changed schedule time for eTag devices to transmit. Additionally, or alternatively, one or more energizers of the system may refrain from sending an energizer signal during the second cycle to reduce or prevent eTag transmission in the eTag uplink slots. This may enable the schedule change information to schedule other UL or DL slots during the eTag uplink slots, and to schedule in accordance with the maximum transmission gap constraint(s).

At 840, the eTags 806 charge based on received second energizer signals, including the second energizer signal from the energizer 804 at 835. For example, one or more of the eTags 806 receive the second energizer signal from the energizer 804 and processes the signal to harvest energy from the signal as described above with reference to 820.

At 845, one or more devices of the devices 808 transmits an UL transmission based on the schedule change information during a second cycle. For example, a UE may transmit an UL beacon transmission or a notification/request in an UL window (or UL slot thereof) based on the schedule change information. The schedule change information may indicate a specific grant for the UE in particular or may indicate a general or group-based grant or grants for multiple UEs, such as multiple UEs in a particular area of the electronic label device system network coverage area. When the UL transmission includes or correspond to an UL beacon, the electronic label device system network (e.g., electronic label device 802) may determine a position for a particular device of the devices 808 based on the UL beacon (e.g., based on measurements by one or more electronic label devices). When the transmission includes a system notification or request, the electronic label device system network (e.g., electronic label device 802) may determine a notification indication for or associated with the particular device of the devices 808, based on a previously determined position for the particular device of the devices 808 or based on a position for the particular device of the devices 808 determined based on measuring the UL notification/request (e.g., based on measurements by one or more controllers).

At 850, one or more of the eTags 806 transmit UL beacons during the second cycle responsive to being charged. For example, a first eTag of the eTags 806 transmits an UL beacon after charging at 840 and during an UL window determined by the scheduling information and optionally a trigger transmission. To illustrate, each eTag 806 may be determine an UL window based on timing/scheduling information and then may determine to transmit during a particular time during the UL window based on being charged (e.g., power/voltage greater than a power/voltage threshold) and based on a random timing backoff. The random timing backoff may be determined based on the Q-value provided by the network or pre-stored at the eTag and one example for determining the timing is illustrated and described with reference to FIG. 10. The UL beacons by the eTags may be used by the electronic label device system and devices interacting with the electronic label device system to determine position measurements and for notifications as described with reference to FIGS. 5-7.

At 855, the device 802 performs an idle operation to transition to and/or remain in an idle mode between the monitoring for and reception of the UL beacons at 850 and the transmission of the DL beacon at 865. For example, the device 802 remains in an operational state for wireless communications and does not reduce or cut power to a transceiver and/or related components based on the schedule change information and/or based on the amount of time or slots between the transmission and reception slots this cycle. The device 802 refrains from performing a power save operation between the monitoring for and reception of the UL beacons at 850 and the transmission of the DL beacon at 865. Other devices (e.g., electronic label devices) that are scheduled for transmit and receive operations this cycle by the schedule change operation may also perform an idle mode operation and transition to or remain in an idle mode between the monitoring for and reception of the UL beacons at 850 and the transmission of the DL beacon at 865. The device 802 remains in the idle state between the DL slots and/or the UL slots indicated in the schedule change information. The device 802 may receive the schedule change information (e.g., DL schedule change information) from a server directly or via another electronic label device system component (e.g., relayed by one or more electronic label device system components) as described above in the examples of FIGS. 6 and 7.

In some aspects, one or more of the devices 808 may also optionally perform an idle mode operation at 860, similar to the idle mode operation by the device 802 at 855. For example, one or more of the devices 808 remains in an operational state for wireless communications and does not reduce or cut power to a transceiver and/or related components based on the schedule change information and/or based on the amount of time or slots between the transmission and reception slots this cycle. One or more of the devices 808 refrains from performing a power save operation between the transmission of UL transmission at 845 and the monitoring for and reception of DL beacons at 865. Other devices (e.g., UEs) that are scheduled for transmit and receive operations this cycle by the schedule change operation may also perform an idle mode operation and transition to or remain in an idle mode between the transmission of UL transmission at 845 and the monitoring for and reception of DL beacons at 865. The devices 808 may receive the schedule change information from a server directly, as illustrated in the example of FIG. 7, or via another electronic label device system component (e.g., relayed by one or more electronic label device system components) as in FIG. 6.

After the schedule change information is transmitted, other devices associated with the system and not scheduled by the schedule change information for any communications this cycle may perform a power save operation and may not engage in transmission or reception operations this cycle. Additionally, or alternatively, other devices associated with the system and not scheduled by the schedule change information for both transmission and reception operations this cycle may perform a power save operation after the single type operations scheduled (e.g., transmit only or receive only).

At 865, the device 802 transmits one or more DL beacons during the second cycle. For example, the device 802 transmits a DL beacon during a first DL slot or window based on the schedule change information and responsive to the second beacon start transmission by an AP (not shown). The first DL slot or window may include or correspond to an originally scheduled DL slot or window or a changed DL slot or window, and which is not more than X number of slots from the UL reception slot assigned to the device 802. For example, the first DL slot or window may have originally been scheduled, assigned, or otherwise reserved for DL transmissions by the controllers and then assigned to the device 802 by being within a threshold number of slots from the schedule receive slot or slots for the device 802. The device 802 may determine the timing of the DL beacon based on the scheduling information, the schedule change information, and/or a second beacon start transmission (e.g., the transmission or reception time thereof) not shown in FIG. 8 for clarity.

Although the example of FIG. 8 illustrates an UL transmission by the devices 808 occurring prior to the UL beacons by the eTags 806, the UL transmission(s) by the devices may occur during and/or after the UL beacons by the eTags in addition to or in the alternative of occurring before in other examples. In such examples, the idle mode operations may occur between a last of these UL transmissions in which the device is scheduled and a first of the DL transmissions in which the device is scheduled.

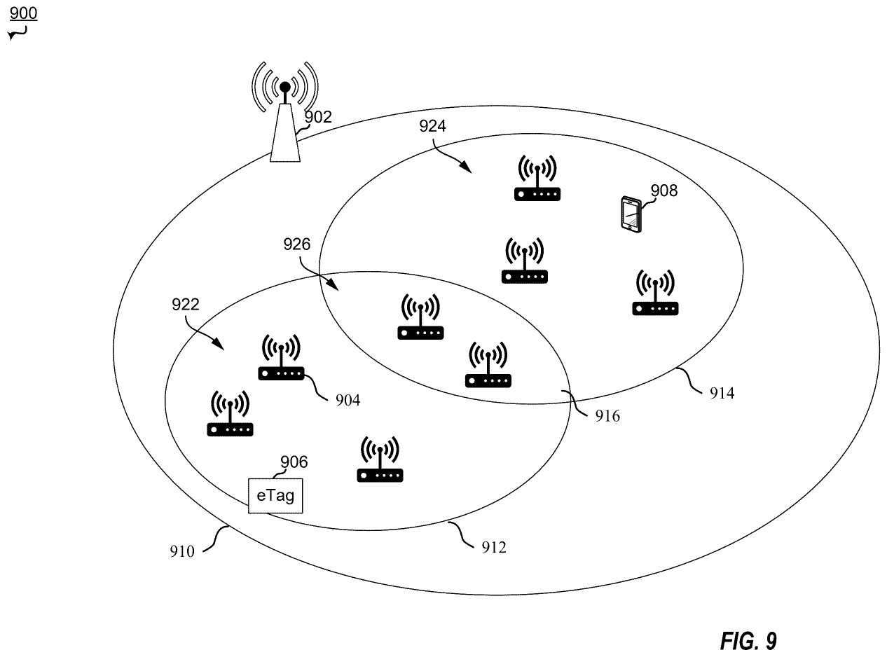

Referring to FIG. 9, diagram 900 illustrates a diagram of an example of an electronic label device system according to one or more aspects of the disclosure. As depicted by diagram 900, the example of electronic label device system may include a coverage area 910 served by an AP 902. The coverage area may include multiple controllers/radios which may be divided or partitioned into groups. For example, as illustrated in FIG. 9, the coverage area includes a first area 912 (e.g., eTag coverage area or eTag range) associated with an eTag 906 and a second area 914 (e.g., UE coverage area or UE range) associated with a UE 908. These areas 912 and 914 may each be associated with, within range of, and/or served by multiple controllers/radios of a plurality of controllers/radios, collectively controllers 904, as shown in FIG. 9. As illustrated in the example of FIG. 9, the areas 912 and 914 may overlap with each other, as shown by the overlap area 916. Accordingly, some of the first controllers 922 associated with the eTag 906 may also be associated with the UE, i.e., part of the second controllers 924 associated with the UE. To illustrate, third controllers 926 in the overlap area 916 are part of the first controllers 922 and the second controllers 924. FIG. 9 illustrates a simplified example of an electronic label device system; the electronic label device system may include multiple APs and multiple AP coverage areas within an electronic label device system coverage area. Additionally, these AP coverage areas might overlap with each other.

The devices of FIG. 9 may include or correspond to one or more devices of the previous figures. For example, the AP 902 may include or correspond to the electronic label device 501 or 802 of FIGS. 5 and 8 or an AP as in FIGS. 6 and 7. The controller/radio may include or correspond to the electronic label device 501 or 802 of FIGS. 5 and 8 or an controller as in FIGS. 6 and 7. The eTag 906 may include or correspond to the eTags 593 of FIG. 5 or the eTags 806 of FIG. 8. The UE 908 may include or correspond to the wireless device 503 of FIG. 5, a device of the devices 608 of FIG. 6, a device of the devices 708 of FIG. 7, or the device 808 of FIG. 8.

In the enhanced scheduling operations for downlink and uplink coexistence described herein, the electronic label device system, such as a server or AP thereof, may determine a transmission gap scheduling constraint for one or more groups of devices (e.g., devices of a particular type, area, resource class, priority, capability, etc., or any combination thereof) and determine to adjust the scheduling information or timing based on the transmission gap scheduling constraint for a particular group, and optionally based on group information. For example, the timing schedule of FIG. 10 may be adjusted to create a schedule or schedule changes where transmission gaps satisfy the constraint, such as by scheduling one group of devices for transmission and reception and not scheduling another group of devices for transmission and reception (e.g., scheduling for a power save or 1-way communication only).

In some aspects, two or more controllers (e.g., a radio or multiple radios associated therewith) of the electronic label device system may be grouped together to create groups for enhanced UL and DL coexistence. For example, as some electronic label device systems may be large, the interference caused by a particular transmission may be local to a particular area and group of devices. The electronic label device system may partition the devices into groups, based on area, device density, device type, device association, maximum idle length, etc., or a combination thereof, using known position information of the electronic label devices, the eTags, and/or the non-electronic label devices. Using groups may further enhance the improvements of above UL and DL coexistence and scheduling adjustment methods by enabling multiple different scheduling adjustments simultaneous and/or enabling scheduling adjustments for one area and not another.

To illustrate, based on a currently known position estimate or setup configuration/information and based on maximum idle length information, a first subset of controllers/radios may be identified by the electronic label device system to operate according to a first schedule during a particular time period. As an example, the subset may be in the vicinity (e.g., within 2 meters, as an illustrative, non-limiting example) of one or more eTags that are charged and/or likely to transmit, in the vicinity of a device or asset that is due for a position update, or in the vicinity of a device that has requested a position-based notification. Similarly, the electronic label device system may identify a second subset of controllers/radios to operate according to a second schedule during the particular time period and that is different from the first schedule. To illustrate, one of the schedules may have time slot gaps between TX and RX slots that satisfy a first maximum idle length constraint, and the other schedule may have time slot gaps between TX and RX slots that satisfy a second maximum idle length constraint that is different from the first maximum idle length constraint. As another illustration, one of the schedules may have time slot gaps between TX and RX slots that satisfy a maximum idle length constraint and the other schedule may have time slot gaps between TX and RX slots that does not satisfy the maximum idle length constraint (e.g., the devices of the second subset perform power save operations between their scheduled TX and RX slots as opposed to idle mode operations.

In some such aspects that involve electronic label device grouping, there may be a time period or event where an eTag and a mobile device are in the same vicinity, as illustrated in the example of FIG. 9. In such situations, this may cause groups of electronic label devices to overlap and have to operate in both transmit and receives modes, consuming more power and leading to more interference. For example, some controllers/radios that are part of a first subset of controllers/radios (e.g., first controllers 922) which are associated with the eTag 906, may also a be part of a second subset of controllers/radios (e.g., second controllers 924) that are associated with the mobile device, the UE 908. These overlapping devices (e.g., third controllers 926) may be configured to operate in both transmit and receive slots, leading to a substantial increase in their power consumption. As such devices may be battery powered, power consumption and power uniformity are important factors that can be managed to reduce the operational costs from batteries and labor to replace batteries. Scheduling and/or adjusting the schedule in accordance with a maximum idle length constraint to conserver power may greatly benefit such situations where devices configured and/or scheduled to operate in both transmit and receive slots in a single cycle.

Additionally, the electronic label device system may modify these groups of devices, such as by modifying the groups and/or by partitioning the groups or making subgroups/subsets, to manage the power consumption and power uniformity and/or to perform scheduling adjustments on a more granular level to enable multiple scheduling changes to be performed locally across the coverage area. To illustrate, in the above example the electronic label device system may determine a third group of controllers/radios may be used in place of the first group of controllers/radios that were originally associated with the eTag. The third group of controllers/radios may include or correspond to a subset of the first group that is created by removing the overlapping devices in the first group, that is the electronic label devices that are part of the first group and part of the second group. To illustrate, third controllers 926 within the overlap area 916 that overlap with/are part of two groups may be removed from the first controllers 922 and/or from the second controllers 924 to create a third group. To determine alternative groups and/or to determine when or how to modify the groups, the electronic label device system may use one or more parameters, such as location, overlap with the second group or groups, battery threshold, estimated remaining battery life, amount of associated groups/devices, etc., or a combination thereof. Modifying groups may enable the system to further conserver power and to increase network resource utilization and throughput through improved used of spatial resources from frequency reuse and/or from using FDMA techniques.

Additionally, or alternatively, the third group may be created by replacing the overlapping devices in the first group with other devices. To determine the other devices to add, the electronic label device system may use one or more parameters, similar to the parameters above for removing devices. As examples, the electronic label devices for replacement may be located closest to a centroid of the locations of the devices in the first subset, be above a threshold value of remaining battery life or capacity (in mAh), not belong to the second group, not belong to other groups.

In some such aspects, the electronic label device system may determine not remove or replace an overlapping device. For example, conditions may exist where not every overlapping controller/radio needs to be removed/replaced. For example, if the electronic label devices are determined to improve precision or meet a particular precision threshold the devices may remain. This determination to keep overlapping devices in one or more groups may also be based on one or more other parameters. To illustrate, the electronic label device system may determine to keep an overlapping device in one or both groups based on a determination that keeping the overlapped device will improve geometric dilution of precision (GDOP), that a remaining battery life value is above a threshold value, or both, as illustrative, non-limiting examples.

Although the example above was described for creating an alternative group or subset (the third subset) for the first group, in other examples and additional or alternative group (e.g., a fourth group) may instead be used in place of the second group for the mobile device. The fourth group may include or correspond to a subset of devices of the second group. The grouping process (e.g., grouping and adjusting/regrouping) may be repeated iteratively as battery levels change and eTags and devices move through the system coverage area.

In some implementations, the electronic label device system may have multiple devices that are awaiting an UL slot or that could have their position updated via transmission of an uplink beacon. For example, the electronic label device system may determine multiple devices are within the system or a region thereof, such as based on prior positioning information, and then the electronic label device system may determine a priority associated with the devices and generate the schedule change information based on the priority. For example, the electronic label device system may identify a particular device in the schedule change information by indicating a specific grant or adjustment for the particular UE.

As an example of the priority determination, the devices may be ranked using one or more parameters, such as latency, battery level, device type, time since last transmission, time since last position determination, etc., or a combination thereof. For example, a device with a low (or high) transmission latency (e.g., time since last transmission) may be given higher or lower priority for scheduling depending on the operations of the electronic label device system, a device associated with a store employee may be assigned a higher or lower priority for scheduling than a customer depending on store operations or parameters, etc. In some such aspects, the devices with a higher priority value or rank, may be scheduled first, such as in a first slot or window, and devices in lower priority values may be scheduled in later slots or windows, and in some cases only after the higher priority devices have actually completed a transmission.

In other such aspects, the multiple devices may be ranked in terms of priority level (e.g., with an absolute ranking or with a grouping, such as high, medium, and low), and the device with the highest priority may be assigned a time slot with the least probability of a transmission and the device with the lowest priority may be assigned a time slot with the highest probability of a transmission.

In some such aspects when priority and/or region-based update/device grouping is used, such aspects may be enabled or disabled based on one or more conditions. For example, the proposed scheme may be disabled when the ratio of the number of eTags to the number of mobile devices exceeds a threshold value (e.g., 2, 3, 4, 5, 10, etc.) or the absolute number of eTags within a given region (e.g., an electronic label device coverage area, an aisle, side of an aisle, portion of an aisle, etc.) exceed a threshold value (e.g., 5, 10, 20, 25, 50, 100, etc.). When there are a large number of eTags, the chances of collisions are much greater, and the mobile devices can continue to be served by DL beacons instead.

In some aspects, the inferred eTag transmission probability can be generalized in the sense of an eTag ‘TX resource opportunity.’ The eTag TX resource opportunity may include or correspond to a combination of time resources, frequency resources, spatial resources (e.g., direction and/or area), and/or coding parameters (e.g., orthogonal-such as cyclic-shifts -or nonorthogonal like PN sequences). Specific coding parameters may also be assigned to the UEs to increase this ‘orthogonalization’. In other words, the use of frequency or code division multiple access can also affect the probability of a slot being occupied or experience interference, and in such aspects the electronic label device system may utilize these additional parameters to determine the eTag transmission probability for a particular Tx resource opportunity and/or region, as opposed to just a transmission time or window (i.e., time resources only).

FIG. 10 is a timing diagram 1000 illustrating an example of a timing schedule for electronic label device system communications. As illustrated in the timing diagram 1000, the electronic label device system includes multiple scheduling schemes and/or time windows for different devices. The timing diagram 1000 includes a beacon timing portion or DL portion time scheme 1002, similar to the timing diagram of FIG. 3. The timing schedule of FIG. 10 supports both UL and DL position determination operations simultaneously. However, the timing schedule of FIG. 10 may not satisfy a timing gap constraint condition, such as maximum idle gap length constraint. As compared to the schedules described herein, such as the schedules described below with respect to FIGS. 11A-11C, the timing schedule of FIG. 10 may cause devices to consume more power and to engage in power save operations between transmit and receive slots (e.g., UL and DL slots).

In the enhanced scheduling operations for downlink and uplink coexistence described herein, the electronic label device system, such as a server or AP thereof, may determine a transmission gap scheduling constraint and determine to adjust the scheduling information or timing of the portions 1002-1006 of the timing diagram 1000 based on the transmission gap scheduling. For example, the timing schedule of FIG. 10 may be adjusted to create a schedule or schedule changes where transmission gaps satisfy the constraint, such as by changing or repurposing any of the currently used time slots (e.g., DL time slots of schemes 1002 or 1004, UL time slots of scheme 1006, or a combination thereof). Repurposing a time slot may include scheduling a different device during the time slot, including with a different transmission direction (e.g., UL or DL).

The timing diagram 1000 also includes an energizer time scheme 1004 shown with respect to the beacon timing portion or DL portion time scheme 1002, where energizing devices transmit energizing signals to eTags. For example, the energizer time scheme 1004 may include transmission of energizing signals sent during a DL portion of the network. The energizing signals may include timing information, such as wake-up and/or synchronization information for eTags. In other implementations, energizers may not be used, and electronic label devices or APs may transmit similar “energizing” transmissions in addition to or in the alternative of the energizers. As an illustrative example, the wake-up signal may include multiple portions, such as a preamble portion (WUS-P) and a data portion (WUS-D), as illustrated in the example of FIG. 10.

The timing diagram 1000 further includes an uplink portion time scheme 1006 shown with reference to eTag transmissions. As described above, the slots of the uplink portion will not always be used by the eTags, as eTags may not be present in the system, may still be charging, or may be performing a random backoff within the window. This UL portion may be repurposed by the electronic label device system to enable devices, such as mobile devices or UEs, to transmit UL beacon transmissions or requests to the electronic label device system and/or to enable devices such as electronic label devices to transmit DL beacons, as described in the above description. For example, a system server may adjust the UL portion or utilize one or more slots of the UL portion for DL transmissions. Additionally, or alternatively, a system server may adjust the DL portion or utilize one or more slots of the DL portion for UL transmissions. This repurposing of UL and DL slots may enable creation of schedules that satisfy a maximum gap or idle length constraint or constraints of system devices to reduce power consumption of the system devices.

The UL portion may include one or more UL windows, and each UL window may include or more slot, and one or more subframes thereof depending on the numerology. As illustrated in the example of FIG. 10, an UL portion includes a single UL window that includes multiple slots. Each slot may include multiple subframes, such as 2, 4, 6, etc. The UL portion may occur anywhere during the system cycle, such as prior to a DL portion (e.g., beacon, energizer, or both), after a DL portion, between two DL portions, etc. In the example of FIG. 10, the UL portion comes after the initial transmission from the AP (e.g., beacon start transmission) and before the responses from the electronic label devices (e.g., beacons) and Energizer transmissions.

The timing diagram 1000, and portions thereof, may represent a base scheduling scheme that is indicated by scheduling/timing information or system configuration information. The timing diagram 1000, and portions thereof, may be adjusted by schedule change information, such as UL schedule change information, DL schedule change information, or both. The schedule change information may indicate additional UL slots or grants for UEs, additional DL slot or grants for beacons, removal of UL slots for eTags, and/or removal of DL slots for electronic label devices (e.g., controllers).

During operation, an eTag may start with energy harvesting (or always be passively energy harvesting) from transmission RF energy to charge a circuit. Once the energy harvested satisfies a threshold, such as a voltage threshold (e.g., 0.5 to 1.5 volts), the eTag may begin a transmission process. For example, the eTag may monitor for a wake-up signal (e.g., WUS-P) or a peak associated therewith to determine when to send a beacon transmission. In some aspects, the eTag may determine whether the wake-up signal satisfies a received power threshold, such as RSSI, in order to filter out wake-up signals that are farther away and/or for other eTags or to determine to perform a backoff procedure. When performing the backoff procedure, the eTag may determine a Q-value and perform a random backoff by selecting M subframes to sleep for between zero and Q. The Q-value may be known to the eTag prior to wake-up or receiving the energizing signal, such as pre-programmed or configured prior to the energy harvesting and energizing signal, or may be indicated by the energizing signal, such as by the WUS-P or WUS-D thereof.

After performing the random backoff, i.e., waiting M subframes, the eTag may transmit perform a clock synchronization operation and transmit in one of the UL slots. After transmission, the eTag will charge again and repeat the process. In some aspects, the eTag will delay a particular number of subframes, such as N, and stay silenced for the subframes before attempting to transmit again (e.g., determine whether the voltage condition is satisfied).

The eTag charging time is well correlated with distance from received signals, such as received beacon transmissions. The eTag charging time may increase exponentially with increasing distance from a beacon (and the corresponding decreasing signal strength associated with the increased distance).

In some aspects, the electronic label device system, such as a server or AP thereof, may determine the eTag transmission probability for one or more eTags of the system and determine to adjust the scheduling information or timing of the portions 1002-1006 of the timing diagram 1000 based further on the eTag transmission probability. For example, the electronic label device system may determine that an eTag or group of eTags in a particular region are not likely to transmit during one or more slots (or subframes) of an UL window, and the electronic label device system may adjust the timing to utilize the likely unused UL time slots for DL transmission or for other UL transmissions (e.g., UL beacons from UEs). Thus, the schedules cans be further adjusted to take advantage of unused UL slots and to meet the transmission gap constraints.

Position estimation as described herein may utilize RSSI, AoA, and/or TOA. In some aspects, the position estimation utilizes RSSI to enable lower complexity devices to engage in measurement operations for position estimation. Other signal quality or strength metrics may be used, such as RSRP or RSRQ.

In some aspects, a centroid algorithm may be used to determine position, such as known in the position determination art. Trilateration using RSSI has been observed to be highly unreliable since the RSSI is very susceptible to attenuation, which in turn leads to poor range estimation accuracy. Instead, a Weighted Centroid Algorithm (WCA) has been observed to be much more robust to attenuation and no-line-of-sight (NLOS) effects. A device, e.g., UE or eTag, position may be estimated by a weighted average of radio positions where the weights are functions of RSSI values.

FIGS. 11A-11C are block diagrams illustrating example schedules that have transmission and reception slots that satisfy a transmission gap condition. The transmission gap condition may correspond to a maximum idle length condition of a device or devices in which staying in an idle mode for the transmission gap between schedule transmission and reception slots consumes less power than powering down after the transmission or reception and powering back up before the other of the transmission or reception. FIGS. 11A and 11B illustrate common RX slot-based schedule examples with one and two common RX slots respectively, and FIG. 11C illustrates a FMDA-based schedule example. Although FIGS. 11A and 11B illustrate common RX slots examples, in other aspects the example schedules herein and other schedules supported by the disclosure may have common TX slots in addition to or in the alternative of the common RX slots. The schedules of FIGS. 11A-11C may be generated by any of the electronic label device systems described herein, and may be generated by a server thereof as an original schedule or as a schedule change.

Each block diagram of FIGS. 11A-11C illustrates a time-frequency schedule where a time domain on the horizontal axis and illustrates corresponding time slots of the schedule for the electronic label device system. In FIGS. 11A and 11B, the block diagrams are for a single frequency resource or channel, and in FIG. 11C the schedule has transmission timing for two frequency resources or channels. Device specific slots are illustrated on the vertical axis. RX slots are illustrated with hashing and TX slots are illustrated without hashing and device identifiers (e.g., E1-E7) are illustrated to identify the device specific slots.

Referring to FIG. 11A, FIG. 11A is a block diagram 1100 illustrating an example schedule with transmission and reception slots for a group of devices (e.g., electronic label devices, UEs, etc.) of an electronic label device system that satisfy a transmission gap condition. In FIG. 11A, the schedule includes a common RX slot in slot 3 in which group devices (e.g., devices of a certain type, such as UEs or electronic label devices) monitor for incoming transmissions. To illustrate, when the device is an electronic label device, the common RX slot corresponds to an uplink slot for transmissions by a UE or eTag. As another illustration, when the device is a UE, the common RX slot corresponds to a downlink slot for transmissions by an electronic label device (or an eTag).

The schedule also includes device specific transmit slots that surround the common RX slot. In the example of FIG. 11A, the schedule includes one device specific transmit slot for each of the four devices (E1-E4), and each transmit slot of the schedule has no more than a 1-slot gap between the transmit slot and the common RX slot. To illustrate, a first device (E1) is scheduled for transmission in a first slot (slot 1) and has a 1-slot gap duration during a second slot (slot 2) to remain idle before monitoring for a reception during the common slot in a third slot (slot 3). A second device (E1) is scheduled for transmission in a second slot (slot 2) and has no transmission gap to remain idle before monitoring for a reception during the common slot in the third slot (slot 3). A third device (E1) is scheduled for transmission in a fourth slot (slot 4) and has no transmission gap to remain idle after monitoring for a reception during the common slot in the third slot (slot 3). A fourth device (E1) is scheduled for transmission in a fifth slot (slot 5) and has a 1-slot gap duration during the fourth slot (slot 4) to remain idle after monitoring for a reception during the common slot in the third slot (slot 3).

Referring to FIG. 11B, FIG. 11B is a block diagram 1110 illustrating another example schedule with transmission and reception slots that satisfy a transmission gap condition for a group of devices. In FIG. 11B, the schedule includes two common RX slots in slots 3 and 4 in which all devices of a certain type (e.g., electronic label device or UE) monitor for incoming transmissions.

The schedule also includes device specific transmit slots that surround the common RX slot, similar to the example of FIG. 11A. In the example of FIG. 11B, the schedule includes one device specific transmit slot for each of the four devices (E1-E4), and each transmit slot of the schedule has no more than a 1-slot gap between the transmit slot and the common RX slots (e.g., to either of the first or the second/last common RX slot). To illustrate, a first device (E1) is scheduled for transmission in a first slot (slot 1) and has a 1-slot gap duration during a second slot (slot 2) to remain idle before monitoring for a reception during the first common slot in a third slot (slot 3). A second device (E1) is scheduled for transmission in a second slot (slot 2) and has no transmission gap to remain idle before monitoring for a reception during the first common slot in the third slot (slot 3). A third device (E1) is scheduled for transmission in a fifth slot (slot 5) and has no transmission gap to remain idle after monitoring for a reception during the second (last) common slot in the fourth slot (slot 4). A fourth device (E1) is scheduled for transmission in a sixth slot (slot 6) and has a 1-slot gap duration during the fifth slot (slot 5) to remain idle after monitoring for a reception during the second (last) common slot in the fourth slot (slot 4).

Although four devices are listed in the schedules of FIGS. 11A and 11B, additional devices or fewer devices may be scheduled in other examples. However, scheduling additional devices may require longer idle periods in some aspects. For example, two additional devices may be scheduled for dedicated transmission slots around each common RX slot for each increase in idle time. However, using frequency reuse for spatially diverse devices and/or FMDA may increase transmission slots and throughput. Additionally, using multiple sets of common RX slots for groups of devices may also enable scheduling more devices. Additionally, although 1-slot idle constraints are illustrated in the examples of FIGS. 11A and 11B, in other examples the idle constraints may be larger (e.g., 2, 3, 4-slot or larger) or smaller (no gap or less than a full time slot gap. The idle constraints may depend on device power consumption for idle mode and power save operations.

Referring to FIG. 11C, FIG. 11C is a block diagram 1120 illustrating an example schedule with transmission and reception slots that satisfy a transmission gap condition for a group of devices (or multiple transmission gap conditions for one or more sets of devices). In FIG. 11C, the schedule includes schedules for two frequency resources or channels during a same time period, such as the same 6 time slots. The schedule of FIG. 11C may include or correspond to a FMDA schedule. The channels may include or correspond to data or advertising channels, such as data or advertising channels of BLE. As illustrated in FIG. 11C, the schedule may include different TX and RX slot formats in different channels. In the example of FIG. 11C, the first channel has two common RX slots, and the second channel has no common RX slots. Additionally, or alternatively, the different channels may have different transmission gap length constraints, different common RX slots (e.g., amount or location), different common TX slots, and/or other scheduling schemes.

Similar to the example of FIG. 11B, the schedule for the first channel has two common RX slots in slots 3 and 4 in which all devices of a certain type (e.g., electronic label device or UE) monitor for incoming transmissions. The schedule for the first channel also has device specific transmit slots that surround the common RX slots with no more than a 1-slot gap between the transmit slot and the common RX slots in FIG. 11C. To illustrate, in the first frequency resource (e.g., first channel), a first device (E1) is scheduled for transmission in a first slot (slot 1) and has a 1-slot gap duration during a second slot (slot 2) to remain idle before monitoring for a reception during the first common slot in a third slot (slot 3). A second device (E1) is scheduled for transmission in a second slot (slot 2) and has no transmission gap to remain idle before monitoring for a reception during the first common slot in the third slot (slot 3). A third device (E1) is scheduled for transmission in a fifth slot (slot 5) and has no transmission gap to remain idle after monitoring for a reception during the second (last) common slot in the fourth slot (slot 4). A fourth device (E1) is scheduled for transmission in a sixth slot (slot 6) and has a 1-slot gap duration during the fifth slot (slot 5) to remain idle after monitoring for a reception during the second (last) common slot in the fourth slot (slot 4).

In the second frequency resource (e.g., second channel), a fifth device (E5) is scheduled for transmission in the third slot (slot 3) and has no transmission gap to remain idle before monitoring for a reception during the fourth slot (slot 4). A sixth device (E6) is scheduled for transmission in the fourth slot (slot 4) and has no transmission gap to remain idle after monitoring for a reception during the third slot (slot 3). A seventh device (E7) is scheduled for transmission in the fifth slot (slot 5) and has a 1-slot gap duration during the fourth slot (slot 4) to remain idle after monitoring for a reception during the second (last) common slot in the third slot (slot 3). In the second channel, the schedule does not include a common RX slot. As compared to prior block scheduling for UL and DL coexistence operations for position-based service systems, such as the scheduling scheme illustrated in FIG. 10, the more granular scheduling schemes of FIGS. 11A-11C with reduced transmission gap lengths that enable reduced or eliminated power save operation may greatly reduce power consumption by system devices. Although three example schedules are illustrated in FIGS. 11A-11C, such are non-limiting examples and systems described herein may use one or more other schedules for devices of the system.

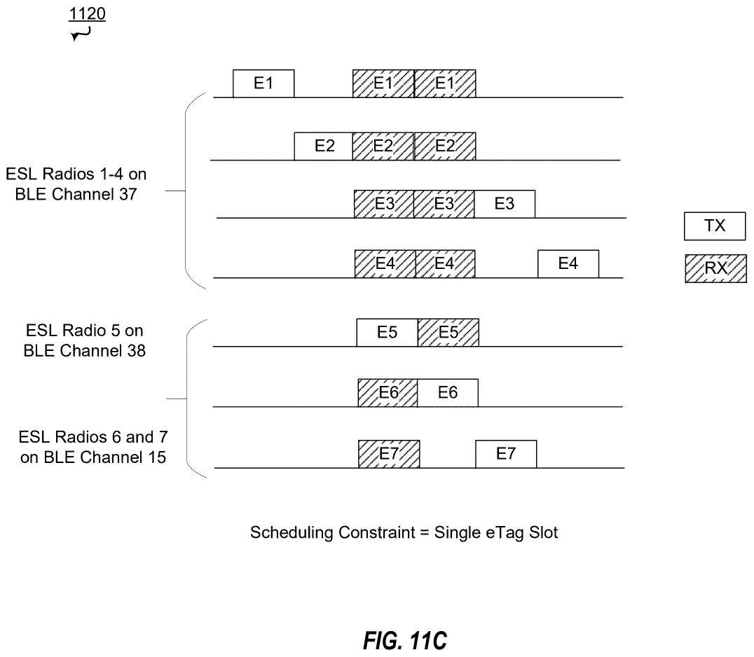

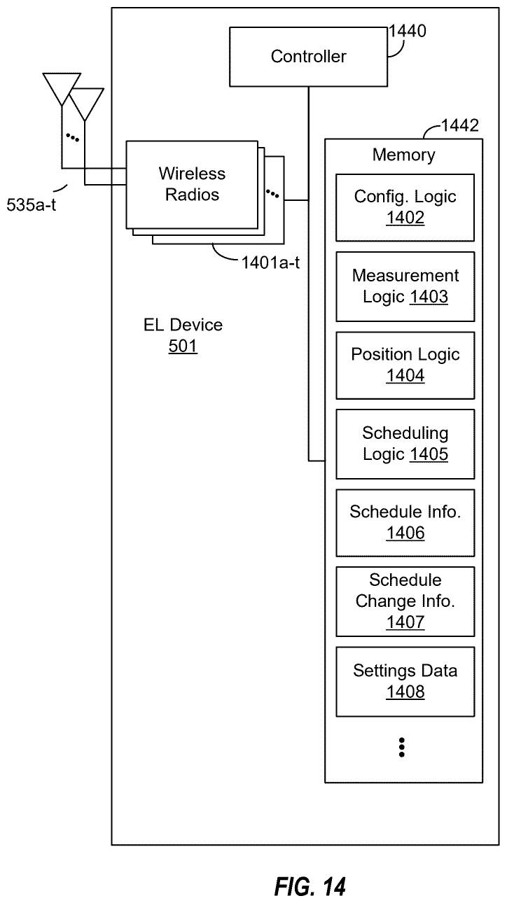

FIG. 12 is a flow diagram 1200 illustrating example blocks executed by wireless communication device (e.g., an electronic label device or a UE) configured according to an aspect of the present disclosure. The example blocks will be described with respect to electronic label device 501 as illustrated in FIG. 14. FIG. 14 is a block diagram illustrating electronic label device 501 configured according to one aspect of the present disclosure. electronic label device 501 includes the structure, hardware, and components as illustrated for electronic label device 501 of any of FIG. 5. For example, electronic label device 501 includes controller/processor 1540, which operates to execute logic or computer instructions stored in memory 1442, as well as controlling the components of electronic label device 501 that provide the features and functionality of electronic label device 501. electronic label device 501, under control of controller/processor 240, transmits and receives signals via wireless radios 1401a-t and antennas 535a-t. As illustrated in the example of FIG. 14, memory 1442 stores one or more of system configuration logic 1402, system measurement logic 1403, system position logic 1504, system scheduling logic 1405, system schedule information 1406, system schedule change information 1407, or settings data 1408. The data (1402-1408) stored in the memory 242 may include or correspond to data and/or logic to enable the operations of FIGS. 5-11C.

At block 1202, a wireless communication device, such as an electronic label device (e.g., a server), receives schedule information for a position services wireless system, wherein the schedule information indicates a schedule that satisfies a maximum transmission gap constraint between transmission and reception slots of a cycle for scheduled devices. The schedule information may include or correspond to configuration information of the configuration transmission 550 or the scheduling information transmission 552, such as the scheduling information 506 and/or the settings information 544 thereof, of FIG. 5, the scheduling change transmission 554, such as the scheduling information 506 indicating a schedule change thereof, of FIG. 5, the scheduling information transmitted at 610-615 of FIG. 6, the schedule change information transmitted at 645-655 of FIG. 6, the scheduling information transmitted at 710-715 of FIG. 7, the schedule change information transmitted at 725-730 of FIG. 7, the scheduling information transmitted at 810 of FIG. 8, or the schedule change information transmitted at 830 of FIG. 8. The electronic label devices may include or correspond to any of the devices associated with and/or controlled by an electronic label device as described in any of FIGS. 5-11C, such as a server, an AP, a controller/radio, or an e-Tag. For example, the electronic label device 501 transmits the scheduling information transmission 552, including the scheduling information 506 and/or the scheduling change transmission 554, including schedule change information, to the electronic label devices 591 and/or to non-electronic label devices (such as to eTags 593 and/or wireless device 503), or both. Other examples are also described in FIGS. 6-8 and FIG. 13.

The scheduling information may have been generated by an EL system to satisfy a maximum transmission gap constraint between transmission and reception slots of a cycle for scheduled devices. In some aspects, the scheduling information corresponds to a semi-static or dynamic schedule that is further based on one or more of transmission requests, system position update priority, transmission probability, etc. In some such aspects, the scheduling information corresponds to schedule change information from a default, static, or semi-static schedule.

At block 1204, the wireless communication device transmits a first transmission during a first transmission slot indicated by the schedule information. The first transmission and first transmission slot may include or correspond the transmission and corresponding slot for the DL transmission 559 of FIG. 5, the DL beacon(s) at 660 of FIG. 6, the DL beacon(s) 735 of FIG. 7, the UL transmission at 845 of FIG. 8, or the DL beacon at 865 of FIG. 8. For example, the electronic label device 501 transmits the DL transmission 559 during a first transmission slot indicated by the scheduling information 506 of the scheduling transmission 552 and/or scheduling change transmission 554. As another example, a controller, such as a first controller of controllers 606, transmits a DL beacon of the DL beacon(s) at 660 of FIG. 6 based on the schedule change information received at 655, and optionally the scheduling information received at 620.

In other aspects, such as for a UE or a non-EL system wireless device, the first transmission and first transmission slot may include or correspond the transmission and corresponding slot for the UL transmission 556 of FIG. 5, the UL beacon(s) at 675 of FIG. 6, the UL transmission at 745 of FIG. 7, or the UL transmission at 845 of FIG. 8. For example, the wireless device 503 transmits the UL transmission 556 during a first transmission slot indicated by the scheduling information 506 of the scheduling transmission 552 and/or scheduling change transmission 554. As another example, a UE, such as a first device of the devices 608, transmits an UL beacon of the UL beacon(s) at 675 of FIG. 6 based on the schedule change information received at 645, and optionally the scheduling information received at 610.

At block 1206, the wireless communication device receives a second transmission during a first reception slot indicated by the schedule information, wherein the device is awake and in an idle mode between the first transmission slot and the first reception slot. The second transmission and first reception slot may include or correspond the reception and corresponding slot for the UL transmission 556 of FIG. 5, the UL beacon(s) at 675 of FIG. 6, the UL transmission at 745 of FIG. 7, or the UL transmission at 845 of FIG. 8. The idle mode may include or correspond to one of the idle operations described with reference to FIGS. 4-8, such as the idle operation at 558 of FIG. 5, the idle operation at 655 of FIG. 6, the idle operation at 670 of FIG. 6, the idle operation at 740 of FIG. 7, the idle operation at 855 of FIG. 8, or the idle operation at 860 of FIG. 8. For example, the electronic label device 501 receives the UL transmission 556 during a first reception slot indicated by the scheduling information 506 of the scheduling transmission 552 and/or scheduling change transmission 554. As another example, a controller, such as a first controller of controllers 606, receives one or more UL beacons of the UL beacon(s) at 675 of FIG. 6 based on the schedule change information received at 655, and optionally the scheduling information received at 620.

In other aspects, such as for the wireless device 503, the second transmission and first reception slot may include or correspond the reception and corresponding slot for the DL transmission 559 of FIG. 5, the DL beacon(s) at 660 of FIG. 6, the DL beacon(s) 735 of FIG. 7, the UL transmission at 845 of FIG. 8, or the DL beacon at 865 of FIG. 8. For example, the wireless device 503 receives the DL beacon(s) 559 during a first reception slot indicated by the scheduling information 506 of the scheduling transmission 552 and/or scheduling change transmission 554. As another example, a UE, such as a first device of the devices 608, receives one or more DL beacons of the DL beacon(s) at 660 of FIG. 6 based on the schedule change information received at 645, and optionally the scheduling information received at 610.

After block 1206, the wireless communication device may engage in position determination operations based on the schedule change information. For example, the wireless communication device may obtain position information and use the position information for notification operations. For example, the electronic label device 501 may transmit notifications to non-electronic label devices responsive to notification requests and indicating a requested location or asset, and may optionally cause electronic label devices to display indications to non-electronic label devices that are associated with the notifications, as described with reference to FIGS. 5-11C.

The wireless communication device (e.g., UE or electronic label device) may execute additional blocks (or the wireless communication device may be configured further to perform additional operations) in other implementations. For example, the wireless communication device, such as one or more processors and one or more memories (e.g., a processing system) thereof, may perform one or more operations described above, such as described with reference to FIGS. 5-11C or as described below. As another example, the wireless communication device may perform one or more aspects as presented below.

Accordingly, wireless communication devices may perform enhanced UL and DL position coexistence operations to dynamically and flexibility use both UL and DL resource to determine position information for position or location based operations, such as position based notification operations. In some aspects, the wireless communication devices may utilize UL-based position estimation operations instead of DL-based position estimation operations to reduce batter consumption. Accordingly, the network performance and user experience may be increased due to enhanced UL and DL position coexistence operations and position based notifications.

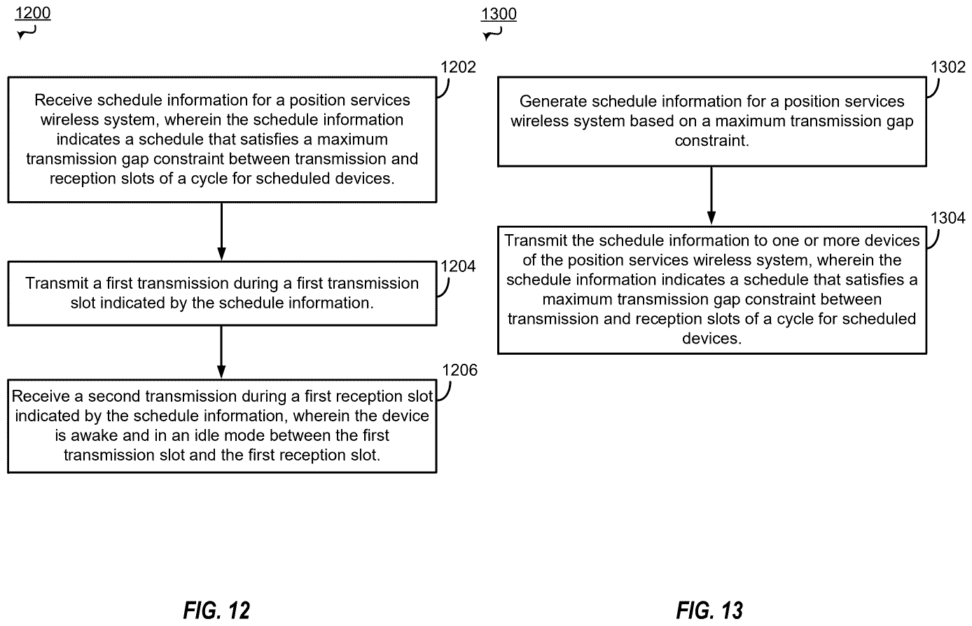

FIG. 13 is a flow diagram 1300 illustrating example blocks executed by wireless communication device (e.g., a UE or an electronic label device) configured according to an aspect of the present disclosure. The example blocks of FIG. 13 will also be described with respect to electronic label device 501 as illustrated in FIG. 14 and described above. The example blocks of FIG. 13 may be practiced by any of the electronic label devices described herein.

At block 1302, a wireless communication device, such as an electronic label device (e.g., server or AP), generates schedule information for a position services wireless system based on a maximum transmission gap constraint. The schedule information may include or correspond to configuration information of the configuration transmission 550 or the scheduling information transmission 552, such as the scheduling information 506 and/or the settings information 544 thereof, of FIG. 5, the scheduling change transmission 554, such as the scheduling information 506 indicating a schedule change thereof, of FIG. 5, the scheduling information transmitted at 610-615 of FIG. 6, the schedule change information transmitted at 645-655 of FIG. 6, the scheduling information transmitted at 710-715 of FIG. 7, the schedule change information transmitted at 725-730 of FIG. 7, the scheduling information transmitted at 810 of FIG. 8, or the schedule change information transmitted at 830 of FIG. 8. For example, a server 602 or 704 generates the scheduling information or scheduling change information based on a transmission gap time or length (e.g., 2 slots) or an AP 604 or 704 generates scheduling change information for transmission based on the scheduling and/or change information received from the server 602 or 702.

At block 1304, the wireless communication device transmits the schedule information to one or more devices of the electronic label device system, wherein the schedule information indicates a schedule that satisfies a maximum transmission gap constraint between transmission and reception slots of a cycle for scheduled devices. For example, the electronic label device 501, the server 602, the server 604, the AP 604, the AP 704, or the device 802 transmits scheduling information or schedule change information to any of wireless device 503, eTags 593, controller 606, controller 706, devices 608, devices 708, devices 808, or eTags 806, as described with reference to FIGS. 5-11C.

The wireless communication device (e.g., such as a UE or base station) may execute additional blocks (or the wireless communication device may be configured further to perform additional operations) in other implementations. For example, the wireless communication device may perform one or more operations as described with reference to FIGS. 5-12 or as described below. As another example, the wireless communication device may perform one or more aspects as presented below.

Accordingly, wireless communication devices may perform enhanced UL and DL position coexistence operations to dynamically and flexibility use both UL and DL resource to determine position information for position or location based operations, such as position based notification operations. In some aspects, the wireless communication devices may utilize UL-based position estimation operations instead of DL-based position estimation operations to reduce batter consumption. Accordingly, the network performance and user experience may be increased due to enhanced UL and DL position coexistence operations and position based notifications.

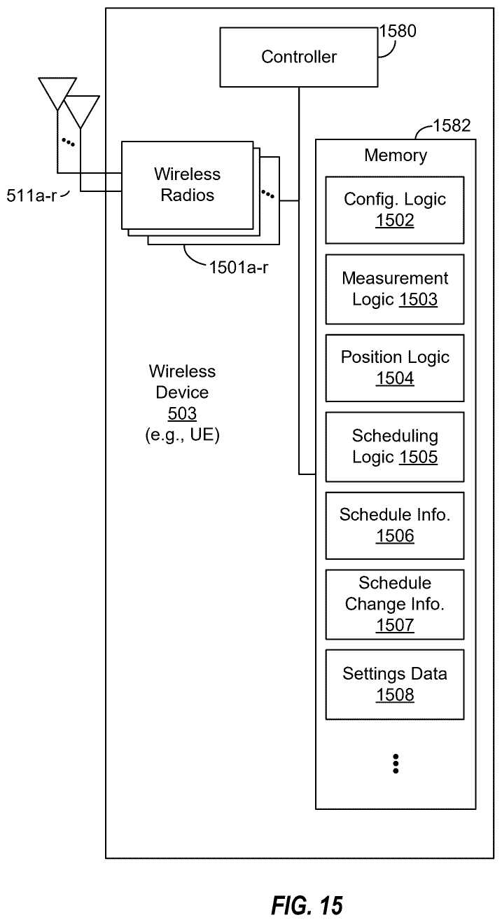

FIG. 15 is a block diagram illustrating wireless device 503 configured according to one aspect of the present disclosure. Wireless device 503 includes the structure, hardware, and components as illustrated for wireless device 503 of FIG. 5. For example, wireless device 503 includes controller/processor 1580, which operates to execute logic or computer instructions stored in memory 1582, as well as controlling the components of wireless device 503 that provide the features and functionality of wireless device 503. Wireless device 503, under control of controller/processor 1580, transmits and receives signals via wireless radios 1501a-r and antennas 511a-r. As illustrated in the example of FIG. 15, memory 1582 stores one or more of system configuration logic 1502, system measurement logic 1503, system position logic 1504, system scheduling logic 1505, system scheduling information 1506, system schedule change information 1507, or settings data 1508. The data (1502-1508) stored in the memory 1582 may include or correspond to data and/or logic to enable the operations of FIGS. 5-11C.

The wireless communication device (e.g., UE or base station) may execute additional blocks (or the wireless communication device may be configured further to perform additional operations) in other implementations. For example, the wireless communication device may perform one or more operations described above, such as described with reference to FIGS. 5-14 and any of the operations described below. As another example, the wireless communication device may perform one or more aspects as presented below.

Accordingly, wireless communication devices may perform enhanced UL and DL position coexistence operations to dynamically and flexibly use both UL and DL resource to determine position information for position or location-based operations with reduce power consumption and increased power efficiency. In some aspects, a position services based wireless system (e.g., an electronic label device system, an ESL system, an IoT system, etc., that provides position/location services) may utilize a time constraint for scheduling transmissions that corresponds to device idle mode power consumption and/or device power down and power up consumption that reduces power save operations and overall power consumption. Accordingly, the network performance and user experience may be increased due to reduced power consumption for UL and DL position coexistence operations and position-based notifications.

In the implementations described herein, an electronic label device system or network may include a cloud server, one or more gateway servers or edge servers associated with the cloud server, one or more APs associated with each gateway or edge server, one or more controllers associated with each AP, one or more electronic label devices associated with each controller, and one or more e-Tags (each associated with one or more assets). In some implementations, the electronic label device system may include a plurality of energizers, which may be associated with multiple e-Tags of the plurality of the e-Tags.

In a first aspect, a device for wireless communication includes: at least one processor; and a memory coupled to the at least one processor, wherein the at least one processor is configured to cause the device to: receive schedule information for a position services wireless system, wherein the schedule information indicates a schedule that satisfies a maximum transmission gap constraint between transmission and reception slots of a cycle for scheduled devices; transmit a first transmission during a first transmission slot indicated by the schedule information; and receive a second transmission during a first reception slot indicated by the schedule information, wherein the device is awake and in an idle mode between the first transmission slot and the first reception slot.

In a second aspect, alone or in combination with the first aspect, the maximum transmission gap constraint (e.g., time between the first transmission slot and the first reception slot) corresponds to a maximum idle period length where the device operating in the idle mode consumes less power than if the device performed a power save operation (e.g., powered down and then powered back-up) during a transmission gap time between the first transmission slot and the first reception slot.

In a third aspect, alone or in combination with one or more of the above aspects, performing the power save operation includes powering down after one of the first transmission slot or the first reception slot and powering up before the other of the first transmission slot or the first reception slot.

In a fourth aspect, alone or in combination with one or more of the above aspects, the first transmission slot and the first reception slot are part of a same cycle of the electronic label device system, and wherein no transmission gap between transmission and reception slots of the same cycle for a device scheduled by the schedule information is greater than the maximum transmission gap constraint.

In a fifth aspect, alone or in combination with one or more of the above aspects, the first transmission and the second transmission correspond to beacon transmissions of the electronic label device system.

In a sixth aspect, alone or in combination with one or more of the above aspects, the schedule information includes one or more common reception slots for multiple devices, including the device, of the electronic label device system, one or more common transmission slots for the multiple devices, or both.

In a seventh aspect, alone or in combination with one or more of the above aspects, the schedule information indicates a second schedule that satisfies a second maximum transmission gap constraint between the transmission and reception slots of the cycle for a second group of devices of the electronic label device system, and wherein the second maximum transmission gap constraint is different from the maximum transmission gap constraint. For example, the schedule information may have different schedules for different time gap constraints for different devices.

In an eighth aspect, alone or in combination with one or more of the above aspects, the maximum transmission gap constraint for a first group of devices of the position services wireless system corresponds to a first schedule for a first frequency channel of the position services wireless system, and wherein the second maximum transmission gap constraint for the second group of devices corresponds to the second schedule for a second frequency channel of the position services wireless system.

In a ninth aspect, alone or in combination with one or more of the above aspects, the maximum transmission gap constraint for a first group of devices of the position services wireless system corresponds to a first schedule for a first frequency channel of the position services wireless system, and wherein the second maximum transmission gap constraint for the second group of devices corresponds to the second schedule for the first frequency channel of the position services wireless system, and wherein the first group of devices are associated with a first region different from a second region of the second group of devices.

In a tenth aspect, alone or in combination with one or more of the above aspects, the maximum transmission gap constraint is less than a duration of two time slots, and wherein a time slot has a duration of 500 to 1000 microseconds (μs).

In an eleventh aspect, alone or in combination with one or more of the above aspects, the at least one processor is further configured to cause the device to: refrain from performing a power save operation between the first transmission slot and the first reception slot based on the schedule information (and optionally based on device maximum idle time).

In a twelfth aspect, alone or in combination with one or more of the above aspects, the at least one processor is further configured to cause the device to: receive downlink schedule change information indicating a schedule for transmissions by one or more electronic label devices of the position services wireless system; receive uplink schedule change information indicating a schedule for transmissions by one or more non-electronic label devices associated with the position services wireless system; or receive combined uplink and downlink schedule change information.

In a thirteenth aspect, alone or in combination with one or more of the above aspects, the at least one processor configured to cause the device to receive schedule information includes to: receive the schedule information in a beacon start transmission or a system information message transmission from an access point of the position services wireless system; receive the schedule information in a system information message transmission or an association message from a server of the position services wireless system; or receive the schedule information in an energizer transmission from an energizer of the position services wireless system.

In a fourteenth aspect, alone or in combination with one or more of the above aspects, one of the first transmission or the second transmission is an uplink beacon transmission for downlink-based position determination operations by the position services wireless system or a position-services notification request to the position services wireless system.

In a fifteenth aspect, alone or in combination with one or more of the above aspects, the other of the first transmission or the second transmission is a downlink beacon transmission for uplink-based position determination operations by non-system devices associated with the position services wireless system.

In a sixteenth aspect, alone or in combination with one or more of the above aspects, the device is an electronic label device, a mobile device, or an electronic tag.

In a seventeenth aspect, alone or in combination with one or more of the above aspects, the at least one processor is further configured to cause the device to: transmit device information to the position services wireless system, the device information including or indicating a maximum idle period for the device where the device can operate in an idle mode between transmission and reception slots and conserve power as compared to performing a power save operation.

In an eighteenth aspect, alone or in combination with one or more of the above aspects, the at least one processor is further configured to cause the device to: receive schedule change information for a second cycle of the position services wireless system, wherein the schedule change information indicates a second schedule that satisfies the maximum transmission gap constraint, a second maximum transmission gap constraint, or both; transmit a third transmission during a second transmission slot of the second cycle and indicated by the schedule change information; and receive a fourth transmission during a second reception slot of the second cycle and indicated by the schedule change information, wherein the device is awake and in an idle mode between the second transmission slot and the second reception slot.

In a nineteenth aspect, alone or in combination with one or more of the above aspects, a method for wireless communication comprises: receiving schedule information for a position services wireless system, wherein the schedule information indicates a schedule that satisfies a maximum transmission gap constraint between transmission and reception slots of a cycle for scheduled devices; transmitting a first transmission during a first transmission slot indicated by the schedule information; and receiving a second transmission during a first reception slot indicated by the schedule information, wherein the device is awake and in an idle mode between the first transmission slot and the first reception slot.

In a twentieth aspect, alone or in combination with one or more of the above aspects, the maximum transmission gap constraint (e.g., time between the first transmission slot and the first reception slot) corresponds to a maximum idle period length where the device operating in the idle mode consumes less power than if the device performed a power save operation (e.g., powered down and then powered back-up) during a transmission gap time between the first transmission slot and the first reception slot.

In an additional aspect of the disclosure, a device for wireless communication comprises: at least one processor; and a memory coupled to the at least one processor. The at least one processor is configured to cause the device to: generate schedule information for a position services wireless system based on a maximum transmission gap constraint; and transmit the schedule information to one or more devices of the position services wireless system, wherein the schedule information indicates a schedule that satisfies a maximum transmission gap constraint between transmission and reception slots of a cycle for scheduled devices.

In another aspect of the disclosure, a method for wireless communication comprises: generating schedule information for a position services wireless system based on a maximum transmission gap constraint; and transmitting the schedule information to one or more devices of the position services wireless system, wherein the schedule information indicates a schedule that satisfies a maximum transmission gap constraint between transmission and reception slots of a cycle for scheduled devices.

Although the foregoing examples have been described with reference to an electronic label device system, the aspects herein can be applied to any wireless network or system, such as IoT networks or systems and systems that engage in position or location services. For example, in some such aspects the electronic label devices may just be electronic devices that enable identification via a user device or terminal by wireless signals and that do include a “label” per se, such as do not include a display.

Components, the functional blocks, and the modules described herein with respect to the figures described above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A device for wireless communication, comprising:
at least one processor; and
a memory coupled to the at least one processor,
wherein the at least one processor is configured to cause the device to:
receive schedule information for a position services wireless system, wherein the schedule information indicates a schedule that satisfies a maximum transmission gap constraint between transmission and reception slots of a cycle for scheduled devices;
transmit a first transmission during a first transmission slot indicated by the schedule information; and
receive a second transmission during a first reception slot indicated by the schedule information, wherein the device is awake and in an idle mode between the first transmission slot and the first reception slot.

2. The device of claim 1, wherein the maximum transmission gap constraint corresponds to a maximum idle period length where the device operating in the idle mode consumes less power than if the device performed a power save operation.

3. The device of claim 2, wherein the at least one processor is further configured to cause the device to perform the power save operation and wherein to perform the power save operation includes to:
power down after one of the first transmission slot or the first reception slot; and
power up before the other of the first transmission slot or the first reception slot.

4. The device of claim 1, wherein the first transmission slot and the first reception slot are part of a same cycle of the position services wireless system, and wherein no transmission gap between transmission and reception slots of the same cycle for a device scheduled by the schedule information is greater than the maximum transmission gap constraint.

5. The device of claim 1, wherein the first transmission and the second transmission correspond to beacon transmissions of the position services wireless system.

6. The device of claim 1, wherein the schedule information includes one or more common reception slots for multiple devices, including the device, of the position services wireless system, one or more common transmission slots for the multiple devices, or both.

7. The device of claim 1, wherein the schedule information indicates a second schedule that satisfies a second maximum transmission gap constraint between the transmission and reception slots of the cycle for a second group of devices of the position services wireless system, and wherein the second maximum transmission gap constraint is different from the maximum transmission gap constraint.

8. The device of claim 7, wherein the maximum transmission gap constraint for a first group of devices of the position services wireless system corresponds to a first schedule for a first frequency channel of the position services wireless system, and wherein the second maximum transmission gap constraint for the second group of devices corresponds to the second schedule for a second frequency channel of the position services wireless system.

9. The device of claim 7, wherein the maximum transmission gap constraint for a first group of devices of the position services wireless system corresponds to a first schedule for a first frequency channel of the position services wireless system, and wherein the second maximum transmission gap constraint for the second group of devices corresponds to the second schedule for the first frequency channel of the position services wireless system, and wherein the first group of devices are associated with a first region different from a second region of the second group of devices.

10. The device of claim 1, wherein the maximum transmission gap constraint is less than a duration of two time slots, and wherein a time slot has a duration of 500 to 1000 microseconds (μs).

11. The device of claim 1, wherein the at least one processor is further configured to cause the device to:
refrain from performing a power save operation between the first transmission slot and the first reception slot based on the schedule information.

12. The device of claim 1, wherein the at least one processor configured to cause the device to receive schedule information includes to:
receive downlink schedule change information indicating a schedule for transmissions by one or more electronic label devices of the position services wireless system;
receive uplink schedule change information indicating a schedule for transmissions by one or more non-electronic label devices associated with the position services wireless system; or
receive combined uplink and downlink schedule change information.

13. The device of claim 1, wherein the at least one processor configured to cause the device to receive schedule information includes to:
receive the schedule information in a beacon start transmission or a system information message transmission from an access point of the position services wireless system;
receive the schedule information in a system information message transmission or an association message from a server of the position services wireless system; or
receive the schedule information in an energizer transmission from an energizer of the position services wireless system.

14. The device of claim 1, wherein one of the first transmission or the second transmission is an uplink beacon transmission for downlink-based position determination operations by the position services wireless system or a position-services notification request to the position services wireless system.

15. The device of claim 14, wherein the other of the first transmission or the second transmission is a downlink beacon transmission for uplink-based position determination operations by non-system devices associated with the position services wireless system.

16. The device of claim 1, wherein the device is an electronic label device, a mobile device, or an electronic tag.

17. The device of claim 1, wherein the at least one processor is further configured to cause the device to:
transmit device information to the position services wireless system, the device information including or indicating a maximum idle period for the device where the device can operate in an idle mode between transmission and reception slots and conserve power as compared to performing a power save operation.

18. The device of claim 1, wherein the at least one processor is further configured to cause the device to:
receive schedule change information for a second cycle of the position services wireless system, wherein the schedule change information indicates a second schedule that satisfies the maximum transmission gap constraint, a second maximum transmission gap constraint, or both;
transmit a third transmission during a second transmission slot of the second cycle and indicated by the schedule change information; and
receive a fourth transmission during a second reception slot of the second cycle and indicated by the schedule change information, wherein the device is awake and in an idle mode between the second transmission slot and the second reception slot.

19. A method for wireless communication, comprising:
receiving schedule information for a position services wireless system, wherein the schedule information indicates a schedule that satisfies a maximum transmission gap constraint between transmission and reception slots of a cycle for scheduled devices;
transmitting a first transmission during a first transmission slot indicated by the schedule information; and
receiving a second transmission during a first reception slot indicated by the schedule information, wherein the device is awake and in an idle mode between the first transmission slot and the first reception slot.

20. The method of claim 19, wherein the maximum transmission gap constraint corresponds to a maximum idle period length where the device operating in the idle mode consumes less power than if the device performed a power save operation
